(19) United States
(12) Patent Application Publication
(10) Pub. No.: US 2007/0065649 A1
(43) Pub. Date: Mar. 22, 2007

(54) Polyester resin

(75) Inventors: Yoshinao Matsui, Otsu-shi (JP); Atsushi Hara, Otsu-shi (JP); Yasuki Nakai, Otsuka-shi (JP); Fumiaki Nishinaka, Otsu-shi (JP); Keiichiro Togawa, Otsu-shi (JP); Naoki Nishimori, Otsu-shi (JP); Takahiro Nakajima, Otsu-shi (JP); Koji Yoshida, Iwakuni-shi (JP); Hirota Nagano, Iwakuni-shi (JP); Kenichi Inuzuka, Iwakuni-shi (JP); Osamu Kimura, Otsu-shi (JP); Yoshitaka Eto, Shiga-gun (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: TOYO BOSEKI KAUSHIKI KAISHA, OSAKA (JP)

(21) Appl. No.: 10/546,959

(22) PCT Filed: Feb. 26, 2004
(86) PCT No.: PCT/JP04/02324

§ 371 Date: Oct. 4, 2006

(30) Foreign Application Priority Data
Feb. 28, 2003 (JP) 2003-053969
Mar. 5, 2003 (JP) 2003-057967

(51) Int. Cl. B32B 27/32; C08G 63/02

(52) U.S. Cl. 428/220; 528/272

(57) ABSTRACT

The invention is a polyester resin mainly comprising a terephthalic acid component and a glycol component, wherein the fluorescence spectrum obtained by irradiating the polyester resin with excited light having a wavelength of 343 nm has a fluorescence intensity at 450 nm (B₀) of 20 or lower. The resin makes it possible to efficiently produce a shaped article, especially a heat-resistant blow-molded article, that has excellent transparency and a moderate and stable crystallization rate and excellent heat-resistance dimensional stability, and is prevented from emitting fluorescence when irradiated with UV rays, and which is excellent in long-run continuous workability with no mold contamination, and which provides a wrapping material having excellent flavor retentiveness.

### TECHNICAL FIELD

The present invention relates to a polyester resin that is favorably used as a material for shaped articles such as blow-molded articles typically including drink bottles, sheets, films, monofilaments; and also relates to a polyester resin composition comprising the polyester resin, and a polyester shaped article comprising either of them. In particular, the invention relates to a polyester resin, which provides shaped articles having excellent transparency and a moderate and stable crystallization rate and having excellent heat-resistant dimensional stability, and which provides shaped articles not emitting fluorescence when irradiated with WV rays, and which provides blow-molded articles, sheets and stretched films that hardly cause contamination of a mold upon molding of a shaped article and further has excellent flavor retentiveness; and also relates to a polyester resin composition comprising the polyester resin.

### BACKGROUND ART

Since polyester has excellent mechanical strength, heat resistance, transparency and gas barrier capability, it is best suited as a material for containers to be filled with drinks such as juices, refreshing drinks and carbonated drinks, and for wrapping films and films for audios and videos, and is used in a large amount.

In addition, polyester is also used in a large amount on a global scale as an industrial material for clothing fabrics and tire cords.

In regard to polyester bottles for drinks, drinks sterilized at high temperatures are filled while still hot, or the bottles are subjected to high-temperature sterilization after filled with drinks. However, ordinary polyester bottles cause a problem that they shrink or deform during such thermal filling treatment.

For improving the heat resistance of polyester bottles, proposed are a method of increasing the degree of crystallinity of the bottle mouth part through heat treatment, and a method of thermally fixing stretched bottles. In particular, when the crystallization of the mouth part is insufficient or when the degree of crystallinity thereof is greatly distributed, then the sealability thereof with a cap becomes poor and the contents may leak out of the bottle. On the other hand, when the degree of crystallinity at the shoulder part, body part, etc. of the bottle is insufficient, then the bottle may undergo thermal deformation and its commercial product may lower.

Specifically, for drinks that require thermal filling, such as fruit juice, oolong tea and mineral water, generally employed is a method of crystallizing the mouth part of a preformed or shaped bottle through heat treatment (JP 55-79237 A, JP 58-110221 A). When an amorphous preform mouth part is thermally crystallized, then spherulite crystallization is promoted and the external appearance of the mouth part turns white, but the degree of crystallinity of the mouth part becomes high and therefore the heat resistance thereof can be improved (that is, the thermal deformation temperature of the mouth part becomes high). For improving the heat resistance of a bottle body part, employed in the art is a method of conducting heat treatment with a stretch-blow mold set at a high temperature of (JP 59-6216 B).

When the shoulder part/body part of a bottle obtained through stretch-blowing of a preform of such type is subjected to heat treatment by contacting them with a high-temperature mold wall, then the formation of fine crystals having a smaller crystal size than spherulites is promoted in addition to the orientation crystallization by stretch-blowing, and therefore the degree of crystallinity is increased and the heat resistance of the bottle can be thereby improved.

In the method as described above that comprises heat-treating the mouth part and the shoulder part of a bottle for improving the heat resistance thereof, the time and the temperature for the crystallization treatment have significant influences on the productivity, and PET capable of being processed at a low temperature and for a short period of time and having a high crystallization rate is preferred. On the other hand, the body part of a bottle is required to stay transparent even when subjected to heat treatment upon molding for not impairing the color tone of the bottle contents and also for the bottle design, and the mouth part and the body part are required to have contradictory characteristics. However, when the crystallization rate of PET is too high, then the crystallization of the preform surface may proceeds during re-heating of the preform before stretch-blowing, thereby raising a problem that the bottle surface becomes whitened after the stretch-blowing and thermal fixation treatment.

For improving the heat resistance of a bottle body part, employed in the art is a method of conducting heat treatment with a stretch-blow mold set at a high temperature (JP 59-6216 B). However, when a large number of bottles are continuously molded by the use of one mold according to the method, then the bottles obtained become whitened and their transparency lowers as the long-run operation goes on. As a result, only bottles with no commercial value could be obtained. It has been found that this is because the mold surface is contaminated with an adhesive deposit caused from PET and the mold contamination is transferred to the bottle surface. In particular, the recent tendency in the art is toward small-sized bottles and rapid shaping operation, and in view of the productivity, shortening the time for heat treatment for crystallization of bottle mouth and prevention of mold contamination are more problematic issues.

Various proposals have been made for solving these problems. For example, there are known a method of adding an inorganic nucleating agent such as kaolin or talc to polyethylene terephthalate (JP 56-2342 A, JP 56-21832 A), and a method of adding an organic nucleating agent such as montanic acid wax salt (JP 57-125246 A, JP 57-207639 A). However, since these methods are accompanied with occurrence of foreign substances and fogs, there are still problems in putting them into practical use. There is known a method of adding, to a starting polyester, a recycled polyester obtained by grinding a polyester shaped article formed through melt molding of the above-mentioned polyester (JP 5-105807 A). However, this method requires the superfluous step of melt-molding and grinding, and it further involves a risk that foreign substances other than polyester may mix in at the time of such a post-treatment step. Accordingly, the method is not preferable from the economical aspect and in terms of the quality of the products. Also proposed is a method of inserting a heat-resistant resin piece into the mouth part of a bottle (JP 61-259946 A, JP 2-269638 A). However, the bottle productivity is poor, and in addition, the method is problematic in recycling efficiency.

When shaped articles that are produced by extruding PET into a sheet, followed by vacuum forming thereof, are filled with food and then they are sealed up each with a cap formed of the same material are left as such for a while, shrinkage occurs and the cap-opening capability may be deteriorated. In addition, when the shaped articles are left as such for a long period of time, then shrinkage occurs so that it may become impossible to fit a cap.

For further solving the above-described problems, there are proposed a PET modification method comprising contacting PET chips with a polyethylene member under a flow condition (JP 9-71639 A); and a PET modification method comprising contacting with a polypropylene resin or polyamide resin member under the same condition (JP 11-209492 A). However, it has been found that, even according to these methods, it is still extremely difficult to obtain a polyester that has a moderate and stable crystallization rate and can give shaped articles having excellent dimensional stability at the mouth part after thermal crystallization and having excellent transparency.

The mouth part of the blow-molded article of the polyester as mentioned above that has been contacted with a polyethylene member has an improved heat-resistant dimensional stability by crystallization through heat treatment with an IR heating device. However, it has been found that, if the crystallization rate of the polyester before the contact treatment is too high, then the crystallization of the mouth part of the blow-molded article from the contact-treated polyester becomes too much and therefore the dimension of the mouth part cannot fall within a standardized value range. As a result, it becomes impossible to carry out normal capping, and the sealability between the cap and the mouth part becomes poor. Therefore, it has been found that this causes a fatal problem that the contents leak out of the bottle. The heating of the mouth part of a blow-molded article is generally made from the outside only, and therefore the outer surface part of the mouth part crystallizes earlier than the inner surface part and the middle part thereof. As a result, the degree of crystallinity of the mouth part becomes uneven between the outer and inner layers thereof. In addition, since the mouth part has a complicated shape having a different thickness, the dimension of the mouth pat fluctuates depending on the crystallinity of polyester and the heating condition employed. Accordingly, in the case of external heating, it has emerged the following facts: when polyester having an extremely high crystallization rate is used, then the dimension of the mouth part significantly fluctuates depending on the heating condition employed, leading to a difficulty in achieving stable operation or an increase in the occurrence frequency of bottles having a mouth part not falling within a standardized value range, and the transparency of the shaped articles obtained becomes poor.

In general, resin chips are dried before shaped, but the drying may be unduly prolonged in various occasions such as when the shaping operation is stopped owing to some trouble. With an ordinary polyester, when polyester which has been subjected to such a prolonged drying is used, then this may cause some troubles that the transparency of the polyester lowers, or the crystallization rate thereof is not stable, or the flavor retentiveness thereof worsens.

In producing polyester for drink containers, frequently employed is a method of increasing the molecular weight through solid-phase polymerization of the polymer chips obtained by melt polymerization. The solid-phase polymerization treatment is carried out at a temperature not higher than the melting point of polyester under reduced pressure or in an inert gas atmosphere. Of those, the continuous solid-phase polymerization method which is widely employed because of its excellent cost performance and which comprises conducting solid-phase polymerization treatment while continuously feeding polyester chips in an inert gas atmosphere, includes a method in which the solid-phase polymerization temperature and the oxygen concentration in the solid-phase polymerization reactor is controlled under a predetermined condition for the purpose of producing polyethylene terephthalate (hereinafter sometimes abbreviated to PET) having excellent flavor retentiveness, specifically, a method in which the solid-phase polymerization treatment is carried out under the condition that satisfies relational expressions: 190≦X≦230 and Y≦−0.8696X+230.0, wherein X (° C.) indicates the solid-phase polymerization temperature and Y (ppm) indicates the oxygen concentration in the solid-phase polymerization reactor (JP 9-59362 A).

For inhibiting the formation of by-products such as acetaldehyde and formaldehyde in solid-phase polymerization reaction for the purpose of obtaining final products having excellent flavor retentiveness, the solid-phase polymerization is carried out in the absence of oxygen and in a hydrogen-containing inert gas atmosphere, specifically, under the conditions in which the oxygen concentration in the inert gas atmosphere in solid-phase polymerization is at most 0.1 mol % of the overall gasses and the hydrogen content of the inert gas is from 0.1 mol % to 70 mol % of the overall gasses (JP 9-3179 A).

There is also proposed a method in which PET produced through solid-phase polymerization is dried in the absence of oxygen and in a hydrogen-containing inert gas stream for reducing acetaldehyde and formaldehyde in the shaped containers for drink (JP 9-3182 A).

However, even according to these methods or even using these polyester resin compositions, the improvement in the flavor retentiveness of containers may be still insufficient, or the crystallization rate of PET may fluctuate. Thus, it has been found that it is extremely difficult to obtain a polyester which has a moderate and stable crystallization rate and which can give shaped articles having excellent dimensional stability at the mouth part thereof after thermal crystallization and having excellent transparency.

In general, resin chips are dried before shaped, but the drying may be unduly prolonged in various occasions such as when the shaping operation is stopped owing to some trouble, or it may be forced to carry out a long time drying for drying a resin containing a large amount of water. With an ordinary polyester, when polyester which has been subjected to such a prolonged drying is used, then this may cause some troubles that the transparency of the polyester lowers, or the crystallization rate thereof is not stable, or the flavor retentiveness thereof worsens.

### BRIEF DESCRIPTION OF THE DRAWINGS

FIG. 1 is a plan view of a stepped shaped plate used in the Examples.

FIG. 2 is a side view of the stepped shaped plate of FIG. 1.

FIG. 3 is a fluorescence spectrum of PET.

### DISCLOSURE OF THE INVENTION

An object of the invention is to provide a polyester resin which solves the problems accompanied with the polyester resin in the related art as mentioned above and which makes it possible to efficiently produce a shaped article, especially a heat-resistant blow-molded article, that has excellent transparency, a moderate and stable crystallization rate and excellent heat-resistant dimensional stability and is prevented from emitting fluorescence when irradiated with UV rays, and which is excellent in long-run continuous workability with no mold contamination, and which provides a wrapping material having excellent flavor retentiveness; and to provide a polyester resin composition and a polyester shaped article. Further, the invention is to provide such a polyester resin, a polyester resin composition and a polyester shaped article which undergo less change in the above-mentioned properties even when subjected to superfluous drying.

The present inventors have extensively studied, using a polyester mainly comprising a terephthalic acid component and a glycol component, on a polyester that can give a shaped article having excellent transparency and heat-resistant dimensional stability and having less crystallization rate fluctuation. As a result, it has been found that the fluorescence intensity of polyester relates to the properties of the shaped article made from the polyester, such as the transparency and the crystallization rate. Thus, the invention was completed.

The invention is as follows:

(1) A polyester resin mainly comprising a terephthalic acid component and a glycol component, wherein the fluorescence spectrum obtained by irradiating the polyester resin with excited light having a wavelength of 343 nm has a fluorescence intensity at 450 nm (B₀) of 20 or lower.

(2) A polyester resin mainly comprising a terephthalic acid component and a glycol component, which gives (Bₕ-B₀) of 30 or less, wherein Bₕ indicates the fluorescence intensity at 450 nm of the fluorescence spectrum obtained by irradiating the polyester resin that has been heat-treated at a temperature of 180° C. for 10 hours, with-excited light having a wavelength of 343 nm, and B₀ indicates the fluorescence intensity at 450 nm, obtained in the same manner, of the non-heated polyester resin.

(3) The polyester resin of (1), which gives (Bₕ-B₀) of 30 or less, wherein Bₕ indicates the fluorescence intensity at 450 nm of the fluorescence spectrum obtained by irradiating the polyester resin that has been heat-treated at a temperature of 180° C. for 10 hours, with excited light having a wavelength of 343 nm, and B₀ indicates the fluorescence intensity at 450 nm, obtained in the same manner, of the non-heated polyester resin.

(4) A polyester resin mainly comprising a terephthalic acid component and a glycol component, which gives (B₀/A₀) of 0.4 or less, wherein A₀ indicates the fluorescence intensity at 395 nm of the fluorescence spectrum obtained by irradiating the polyester resin with excited light having a wavelength of 343 nm, and B₀ indicates the fluorescence intensity at 450 nm thereof.

(5) The polyester of any of (1) to (3), which gives (B₀/A₀) of 0.4 or less, wherein A₀ indicates the fluorescence intensity at 395 nm of the fluorescence spectrum obtained by irradiating the polyester resin with excited light having a wavelength of 343 nm, and B₀ indicates the fluorescence intensity at 450 nm thereof.

(6) A polyester resin mainly comprising a terephthalic acid component and a glycol component, which gives a difference between a ratio (Bₕ/Aₕ) and a ratio (B₀/A₀) of 0.7 or less, wherein Aₕ and Bₕ indicate the fluorescence intensities at 395 nm and at 450 nm respectively of the fluorescence spectrum obtained by irradiating the resin that has been heat-treated at a temperature of 180° C. for 10 hours, with excited light having a wavelength of 343 nm, and A₀ and B₀ indicate the fluorescence intensities at 395 nm and at 450 nm respectively, obtained in the same manner, of the non-heated polyester resin.

(7) The polyester resin of any of (1) to (5), which gives a difference between a ratio (Bₕ/Aₕ) and a ratio (B₀/A₀) of 0.7 or less, wherein Aand Bₕ indicate the fluorescence intensities at 395 nm and at 450 nm respectively of the fluorescence spectrum obtained by irradiating the polyester resin that has been heat-treated at a temperature of 180° C. for 10 hours, with excited light having a wavelength of 343 nm, and A₀ and B₀ indicate the fluorescence intensities at 395 nm and at 450 nm respectively, obtained in the same manner, of the non-heated polyester resin.

(8) A polyester resin, which gives (Bₛ₀/Aₛ₀) of 0.3 or less, wherein Aₛ₀ and Bₛ₀ indicate the fluorescence intensities at 395 nm and at 450 nm respectively of the fluorescence spectrum obtained by irradiating a chip selected from the polyester resin which mainly comprises a terephthalic acid component and a glycol component and which is in the form of chip, with excited light having a wavelength of 343 nm.

(9) A polyester resin, which gives (Bₛ₀/Aₛ₀) of 0.3 or less, wherein Aₛ₀ and Bₛ₀ indicate the fluorescence intensities at 395 nm and at 450 nm respectively of the fluorescence spectrum obtained by irradiating a selected fluorescence-emitting chip which is the polyester resin of any one of (1) to (9) and which is in the form of chip, with excited light having a wavelength of 343 nm.

(10) A polyester resin, which gives (Bₛₕ/Aₛₕ) of 0.5 or less, wherein Aₛₕ and Bₛₕ indicate the fluorescence intensities at 395 nm and at 450 nm respectively of the fluorescence spectrum obtained by irradiating a fluorescence-emitting chip selected from the polyester resin in the form of chip which mainly comprises a terephthalic acid component and a glycol component and which has been heat-treated at a temperature of 180° C. for 10 hours, with excited light having a wavelength of 343 nm.

(11) A polyester resin, which gives (Bₛₕ/Aₛₕ) of 0.5 or less, wherein Aₛₕ and Bₛₕ indicate the fluorescence intensities at 395 nm and at 450 nm respectively of the fluorescence spectrum obtained by irradiating a fluorescence-emitting chip selected from the polyester resin in the form of chip of any one of (1) to (7) which has been heat-treated at a temperature of 180° C. for 10 hours, with excited light having a wavelength of 343 nm.

(12) The polyester resin of any of (1) to (11), which gives an increment in color b value when heat-treated at a temperature of 180° C. for 10 hours of 4 or less.

(13) The polyester resin of any of (1) to (12), which comprises ethylene terephthalate as a main repetitive unit and which has a cyclic trimer content of 0.7% by weight or less.

(14) The polyester resin of any of (1) to (13), which gives an increment of cyclic ester oligomer when melted at a temperature of 290° C. for 60 minutes of 0.50% by weight or less.

(15) The polyester resin of any of (1) to (16), which contains polyester fines having the same composition as that of the polyester in an amount of from 0.1 to 10000 ppm, wherein the fines have a melting point, as measured through DSC, of 265° C. or lower.

(16) The polyester resin of any of (1) to (15), which gives a dimensional change, as measured through thermomechanical analysis (TMA) on a shaped plate obtained through injection molding of the resin and having a thickness of 3 mm, of from 1.0% to 7.0%.

(17) A polyester resin composition comprising the polyester resin of any of (1) to (16), and at least one resin selected from the group consisting of polyolefin resin, polyamide resin and polyacetal resin in an amount of from 0.1 ppb to 50000 ppm of the polyester resin.

The polyester resin of the invention has the specific fluorescence-emitting characteristics as mentioned above, and satisfies any of the following formula (1) to formula (6) in which A₀, B₀, Aₕ, Bₕ, Aₛ₀, Bₛ₀, Aₛₕ and Bₛₕ are defined as shown below. The characteristics represented by these formulae may be sometimes collectively referred to as fluorescence-emitting characteristics.
(B₀)≦20, (2)
(Bₕ−B₀)≦30, (2)
(B₀/A₀)≦0.4, (3)
(Bₕ/Aₕ)−(B/A)≦0.7, (4)
(Bₛ₀/Aₛ₀)≦0.3, (5)
(Bₛₕ/Aₛₕ)≦0.5. (6)

A₀: The fluorescence intensity at 395 nm of the fluorescence spectrum obtained by irradiating the polyester resin with excited light having a wavelength of 343 nm.

B₀: The fluorescence intensity at 450 nm of the fluorescence spectrum obtained by irradiating the polyester resin with excited light having a wavelength of 343 rim.

Aₕ: The fluorescence intensity at 395 nm of the fluorescence spectrum obtained by irradiating the polyester resin that has been heat-treated at a temperature of 180° C. for 10 hours, with excited light having a wavelength of 343 nm.

Bₕ: The fluorescence intensity at 450 nm of the fluorescence spectrum obtained by irradiating the polyester resin that has been heat-treated at a temperature of 180° C. for 10 hours, with excited light having a wavelength of 343 nm.

Aₛ₀: The fluorescence intensity at 395 nm of the fluorescence spectrum obtained by irradiating, with excited light having a wavelength of 343 nm, the fluorescence-emitting chips that have been selected according to the method described in the section of measurement methods in the Examples while irradiating them with excited light of UV rays of from 300 to 400 nm having a maximum wavelength of 352 nm.

Bₛ₀: The fluorescence intensity at 450 nm of the fluorescence spectrum obtained by irradiating, with excited light having a wavelength of 343 nm, the fluorescence-emitting chips that have been selected according to the method described in the section of measurement methods in the Examples while irradiating them with excited light of UV rays of from 300 to 400 nm having a maximum wavelength of 352 nm.

Aₛₕ: The fluorescence intensity at 395 nm of the fluorescence spectrum obtained by irradiating, with excited light having a wavelength of 343 nm, the fluorescence-emitting chips that have been heat-treated at a temperature of 180° C. for 10 hours and then selected according to the method described in the section of measurement methods in the Examples while irradiating them with excited light of UV rays of from 300 to 400 nm having a maximum wavelength of 352 nm.

Bₛₕ: The fluorescence intensity at 450 nm of the fluorescence spectrum obtained by irradiating, with excited light having a wavelength of 343 nm, the fluorescence-emitting chips that have been heat-treated at a temperature of 180° C. for 10 hours and then selected according to the method described in the section of measurement methods in the Examples while irradiating them with excited light of UV rays of from 300 to 400 nm having a maximum wavelength of 352 nm.

In the invention, the fluorescence intensity (B₀) at 450 nm of the polyester is preferably at most 15, more preferably at most 10, even more preferably at most 7.

(Bₕ-B₀) is preferably at most 25, more preferably at most 20, most preferably at most 15.

(B₀/A₀) is preferably at most 0.30, more preferably at most 0.20, most preferably at most 0.10.

(Bₕ/Aₕ)−(B₀/A₀) is preferably at most 0.5, more preferably at most 0.45, even more preferably at most 0.40, most preferably at most 0.35.

(Bₛ₀/Aₛ₀) is preferably at most 0.20, more preferably at most 0.10, most preferably at most 0.07.

(Bₛₕ/Aₛₕ) is preferably at most 0.45, more preferably at most 0.40, most preferably at most 0.35.

It is not always necessary to satisfy all these fluorescence-emitting characteristics. Preferably, however, at least 2 or more, more preferably at least 3 or more, even more preferably at least 4 or more, still more preferably at least 5 or more of these are satisfied in any combinations. Most preferably, all of these are satisfied.

When the fluorescence-emitting characteristics of the polyester resin do not fall within the ranges as described above, then the crystallization rate of the mouth part of the blow-molded article obtained from the polyester resin of the type may be too high and therefore the dimension of the mouth part could not fall within the standardized value range and, in addition, the difference between the degree of crystallinity of the outer surface part of the mouth of the thermally-crystallized, blow-molded article and the degree of crystallinity of the inner surface part and the middle part thereof may be too large, and therefore the non-uniformity of the degree of crystallization of the mouth part may increase, and the fluctuation of the degree of crystallinity may be extremely great between different molded articles. Because of these reasons, the degree of shrinkage of the mouth part could not fall within a standardized value range, and capping failure may occur at the mouth part therefore causing leakage of contents. In addition, blow-molding preforms may be whitened, and the transparency of the blow-molded articles obtained by blow-molding the preforms would be extremely poor and, as the case may be, normal blow-molding may be impossible. In addition, when shaped articles such as blow-molded articles of the polyester resin of the type are irradiated with UV rays and visually observed, then they may exhibit unfavorable characteristics that they emit strong bluish white light, and therefore their commercial value may lower. These problems are more serious when the resin is exposed to long-term drying before molded.

Our studies revealed that a polyester mainly comprising a terephthalic acid component and a glycol component naturally has fluorescence-emitting characteristics, and when this is irradiated with excited light at 343 nm, then it emits fluorescence having a peak at 395 nm and falling within a range of up to about 600 nm. According to the method described in the section of measurement methods, the emitted fluorescence spectrum is analyzed within a range of from 350 nm to 600 nm and the relative intensity of the emitted fluorescence at 450 nm is obtained. In the invention, this is referred to as a fluorescence intensity.

We have found that the fluorescence intensity peak at 395 nm of the normal polyester produced with the greatest care in a laboratory is at most 85, and the fluorescence intensity at 450 nm thereof is at most 20.

In the invention, the fluorescence means the light that is emitted by a substance which has absorbed light energy to be in an excited state when it is restored to its ground state, as so described in Analytical Chemistry Experiment Handbook (edited by the Analytical Chemical Society of Japan, page 425, Maruzen). The radiated fluorescence intensity “If” is in proportional to the intensity of the absorbed excited light “Ia” and the quantum yield “φf”, and is defined by the formula: If=kIφf. Since the excited light absorption follows the Lambert-Beer's law, If=kIo(1-10^{-ecd})φf. In this formula, k indicates a device constant such as light collection and detection efficiency; Io indicates an intensity of excited light; e indicates a molar extinction coefficient; c indicates a sample concentration; and d indicates a length of the sample layer. When the excited fluorescence wavelength and the device condition are made constant, e and φf are values intrinsic to the sample and therefore these values are irrelevant within the same sample. As a result, the above formula can be represented as follows: If=kc, and the fluorescence intensity may be represented as a relative intensity.

However, it has been found that the fluorescence intensity of the polyester resin is influenced by the quality, the polycondensation method, the polycondensation device, the polycondensation condition, the drying method, the drying device and the drying condition of terephthalic acid to be employed for the resin. In particular, it has been found that when conducting industrial-scale continuous production, there are marked tendencies that the fluorescence intensity of the resin may increase and that various resin chips that differ in the fluorescence intensity or fluorescence spectrum thereof may be present with being mixed. When conducting continuous production by the use of a batch-type melt polycondensation device or a subsequent batch-type solid-phase polymerization device, the tendency is remarkable. Accordingly, it is important to produce the polyester resin under the conditions satisfactory for ensuring the normal fluorescence intensity of the resin and for eliminating as much as possible or minimizing polyester having a different fluorescence intensity or a different fluorescence spectrum, and the method for producing it is described below. The reasons why the fluorescence intensity of the polyester resin increases or why polyester resin chips differing in the fluorescence intensity or fluorescence spectrum thereof are present with being mixed are presumably considered as being attributable to that the resin itself or an organic substance taken in the resin may be decomposed through thermal oxidation and a minor amount of a fluorescent substance may be thereby produced. However, the causes have not been elucidated. Further, the problems do not depend on what are the cases.

The fluorescence intensity and the fluorescence intensity increment of the polyester resin may be determined according to the methods mentioned below.

The polyester resin composition of the invention has excellent transparency and less transparency fluctuation. In addition, it is prevented from emitting fluorescence when irradiated with UV rays, it does not emit fluorescence; and during molding, it is less apt to contaminate molds used; and further, it gives a shaped article having excellent crystallization controllability at its mouth part. The polyester resin composition gives a blow-molded article, a sheet, a stretched film and a monofilament, which have excellent heat resistance and excellent mechanical properties, which have less residual foreign taste and less foreign odor, and which have excellent flavor retentiveness.

### BEST MODE FOR CARRYING OUT THE INVENTION

Embodiments of the polyester resin and the polyester resin composition of the invention and their use are specifically described below.

The polyester resin of the invention is a polyester resin obtained mainly from a terephthalic acid component and a glycol component, preferably a polyester resin that contains at least 70 mol %, more preferably at least 85 mol %, even more preferably at least 95 mol % or more of the constitutive units obtained from a terephthalic acid component and a glycol component.

The glycol component constituting the polyester resin of the invention includes aliphatic glycols such as ethylene glycol, 1,3-propylene glycol, tetramethylene glycol; and alicyclic glycols such as cyclohexanedimethanol.

A dicarboxylic acid for use as a comonomer component when the polyester resin is a copolymer, includes aromatic dicarboxylic acids such as isophthalic acid, diphenyl-4,4′-dicarboxylic acid, diphenoxyethanedicarboxylic acid, 4,4′-diphenylether-dicarboxylic acid, 4,4′-diphenylketone-dicarboxylic acid, and their functional derivatives; hydroxy acids such as p-hydroxybenzoic acid, hydroxycaproic acid and their functional derivatives; aliphatic dicarboxylic acids such as adipic acid, sebacic acid, succinic acid, glutaric acid, dimer acid, and their functional derivatives; alicyclic dicarboxylic acids such as hexahydroterephthalic acid, hexahydroisophthalic acid, cyclohexanedicarboxylic acid, and their functional derivatives.

A glycol for use as a comonomer component when the polyester resin is a copolymer, includes aliphatic glycols such as diethylene glycol, 1,3-trimethylene glycol, tetramethylene glycol, pentamethylene glycol, hexamethylene glycol, octamethylene glycol, decamethylene glycol, 2-ethyl-2-butyl-1,3-propanediol, neopentyl glycol, dimer glycol; alicyclic glycols such as 1,2-cyclohexanediol, 1,4-cyclohexanediol, 1,1-cyclohexanedimethylol, 1,4-cyclohexanedimethylol, 2,5-norbornanedimethylol; aromatic glycols such as xylylene glycol, 4,4′-dihydroxybiphenyl, 2,2-bis(4′-β-hydroxyethoxyphenyl)propane, bis(4-hydroxyphenyl)sulfone, bis(4-β-hydroxyethoxyphenyl)sulfonic acid, bisphenol A/alkyleneoxide adduct; polyalkylene glycols such as polyethylene glycol, polybutylene glycol.

Regarding a polyfunctional compound for use as a comonomer component when the polyester resin is a copolymer, the acid component includes trimellitic acid, pyromellitic acid; and the glycol component includes glycerin, pentaerythritol. The amount of the foregoing comonomer component to be used must be such that the polyester resin stays substantially linear. A monofunctional compound such as benzoic acid or naphthoic acid may also be copolymerized.

One preferred embodiment of the polyester resin of the invention is a polyester resin comprising ethylene terephthalate as a main constitutive unit thereof, more preferably a copolyester resin that contains at least 70 mol % of ethylene terephthalate units and contains, as a comonomer component, isophthalic acid or 1,4-cyclohexanedimethanol, even more preferably a polyester resin containing at least 90 mol % of ethylene terephthalate units.

Examples of the polyester resins are polyethylene terephthalate (hereinafter abbreviated as PET), poly(ethylene terephthalate-ethylene isophthalate)copolymer, poly(ethylene terephthalate-1,4-cyclohexanedimethylene terephthalate)copolymer, poly(ethylene terephthalate-dioxyethylene terephthalate)copolymer, poly(ethylene terephthalate-1,3-propylene terephthalate)copolymer, poly(ethylene terephthalate-ethylene cyclohexylene dicarboxylate)copolymer.

Another preferred embodiemnt of the polyester resin of the invention is a polyester resin comprising 1,3-propylene terephthalate as a main constitutive unit thereof, more preferably a polyester resin that contains at least 70 mol % of 1,3-propylene terephthalate units, even more preferably a polyester resin containing at least 90 mol % of 1,3-propylene terephthalate units.

Examples of these polyester resins include polypropylene terephthalate (PTT), poly(1,3-propylene terephthalate-1,3-propylene isophthalate)copolymer, and poly(1,3-propylene terephthalate-1,4-cyclohexanedimethylene terephthalate)copolymer.

Still another preferred embodiment of the polyester resin of the invention is a polyester resin comprising butylene terephthalate as a main constitutive unit thereof, more preferably a copolyester resin that contains at least 70 mol % of butylene terephthalate units, even more preferably a polyester resin containing at least 90 mol % of butylene terephthalate units.

Examples of these polyester resins are polybutylene terephthalate (PBT), poly(butylene terephthalate-butylene isophthalate)copolymer, poly(butylene terephthalate-1,4-cyclohexanedimethylene terephthalate)copolymer, poly(butylene terephthalate-1,3-propylene terephthalate)copolymer, poly(butylene terephthalate-butylenecyclohexylene-dicarboxylate)copolymer.

The polyester resin may be produced basically according to a continuous melt polycondensation method or a continuous melt polycondensation-continuous solid-phase polymerization method heretofore known in the art. Specifically, PET may be produced according to a direct esterification method that comprises esterification by directly reacting terephthalic acid and ethylene glycol and optionally any other comonomer component and removing water through distillation followed by polycondensation under reduced pressure; or an interesterification method that comprises interesterification by reacting dimethyl terephthalate and ethylene glycol and optionally any other comonomer component and removing methyl alcohol through distillation followed by polycondensation under reduced pressure.

Next, as needed, the polyester resin thus obtained through such melt polycondensation may be subsequently and continuously subjected to solid-phase polymerization for the purpose of increasing the intrinsic viscosity of the polymer, or for reducing the acetaldehyde content or the low-cyclic trimer content of the polymer so that the polymer could be used for flavorless heat-resistant containers for drinks or for inner surface films for metal bottles for drinks.

With reference to polyethylene terephthalate as an example, one preferred example of continuous production of the polyester resin of the invention is described below, but the method for producing the polyester resin of the invention should not be construed as being limited thereto.

Firstly, a case of producing a low polymer through esterification is described. One mol of high-purity terephthalic acid or its ester derivative is mixed with from 1.02 to 1.9 mols, preferably from 1.03 to 1.7 mols of ethylene glycol to prepare a slurry, and this is continuously fed to an esterification step.

In this stage, it is desirable that an inert gas having an oxygen concentration of at most 5 ppm, preferably at most 3 ppm, more preferably at most 2 ppm, most preferably at most 1 ppm is made to run through the gaseous phase part in the slurry preparing chamber or the slurry storing chamber, whereby oxygen that may enter into the reaction system along with the starting materials is removed and air is also prevented from entering into the system. It is desirable that the oxygen concentration in the gaseous phase is at most 100 ppm, preferably at most 70 ppm, more preferably at most 50 ppm, even more preferably at most 30 ppm, most preferably at most 10 ppm.

In particular, since high-purity terephthalic acid is generally powdery and involves air between its particles, it brings oxygen into the slurry preparing chamber and the slurry storing chamber. Therefore, it is desirable that oxygen is sufficiently purged or the atmosphere inside the storage silo of terephthalic acid is replaced with an inert gas atmosphere having an oxygen concentration of at most 200 ppm, preferably at most 100 ppm, more preferably at most 50 ppm, still more preferably at most 30 ppm, most preferably at most 10 ppm.

In addition, since ethylene glycol also contains oxygen dissolving therein, it is desirable that ethylene glycol is previously subjected to bubbling with an inert gas having an oxygen concentration of at most 5 ppm, preferably at most 3 ppm, more preferably at most 2 ppm, most preferably at most 1 ppm, and the slurry preparing chamber and the slurry storing chamber are also subjected to bubbling with the inert gas as described above after slurry preparation.

Using a one-stage device comprising one esterification reactor or a multi-stage device comprising at least two esterification reactors connected in series, the esterification is carried out under conditions where reflux of ethylene glycol is attained, while an inert gas having an oxygen concentration of at most 5 ppm, preferably at most 3 ppm, more preferably at most 2 ppm, most preferably at most 1 ppm is made to run through the gaseous phase part and while water or alcohol produced during the reaction is removed out of the system via a distillation tower. It is desirable that the oxygen concentration in the gaseous phase is kept to be at most 100 ppm, preferably at most 70 ppm, more preferably at most 50 ppm, even more preferably at most 30 ppm, most preferably at most 10 ppm.

In the first-stage esterification, the temperature is from 240 to 270° C., preferably from 245 to 265° C., and the pressure is from 0.2 to 3 kg/cm²G, preferably from 0.5 to 2 kg/cm²G. In the final-stage esterification, the temperature is generally from 250 to 275° C., preferably from 255 to 270° C., and the pressure is generally from 0 to 1.5 kg/cm²G, preferably from 0 to 1.3 kg/cm²G. In the case where the reaction is three-stage or more multi-stage reaction, the reaction condition for the intermediate-stage esterification may fall between the first-stage reaction condition and the final-stage reaction condition. Preferably, the increase in the esterification reactivity is smoothly distributed over the respective stages. The final esterification reactivity is preferably at least 90% or more, more preferably at least 93% or more. The foregoing esterification gives a low-order condensate having a molecular weight of approximately from 500 to 5000.

When terephthalic acid is used as the starting material in the above esterification, then the reaction can proceed even in the absence of a catalyst due to the catalytic action as an acid served by terephthalic acid, but the reaction may be effected in the presence of a polycondensation catalyst.

When a small amount of a tertiary amine such as triethylamine, tri-n-butylamine, benzyldimethylamine, a quaternary ammonium hydroxide such as tetraethylammonium hydroxide, tetra-n-butylammonium hydroxide, trimethylbenzylammonium hydroxide, or a basic compound such as lithium carbonate, sodium carbonate, potassium carbonate or sodium acetate is added to the reaction system, then the ratio of the dioxyethylene terephthalate component units in the main chain of the polyethylene terephthalate may be kept at a relatively low level (at most 5 mol % of all the diol component). Hence, this is preferable.

Next, in the case where a low polymer is produced through interesterification, a solution containing from 1.1 to 1.8 mols, preferably from 1.2 to 1.6 mols of ethylene glycol per 1 mol of dimethyl terephthalate is prepared and this is continuously fed into an interesterification step.

At this stage, it is desirable that an inert gas having an oxygen concentration of at most 5 ppm, preferably at most 3 ppm, more preferably at most 2 ppm, most preferably at most 1 ppm is made to run through the gaseous phase part in the ethylene glycol solution dissolving chamber or the solution storage chamber, whereby oxygen that may enter into the reaction system along with the starting materials is removed and air is also prevented from entering into the system. It is desirable that the oxygen concentration in the gaseous phase is at most 100 ppm, preferably at most 70 ppm, more preferably at most 50 ppm, even more preferably at most 30 ppm, most preferably at most 10 ppm. Also preferably, the dissolution chamber is subjected to bubbling with an inert gas having an oxygen concentration of at most 5 ppm, preferably at most 3 ppm, more preferably at most 2 ppm, most preferably at most 1 ppm.

In particular, since dimethyl terephthalate is powdery or flaky and involves air between its particles, it brings oxygen into the dissolution chamber and the storage chamber. Therefore, it is desirable that oxygen is sufficiently purged or the atmosphere inside the storage silo of dimethyl terephthalate is replaced with an inert gas atmosphere having an oxygen concentration of at most 100 ppm, preferably at most 70 ppm, more preferably at most 50 ppm, still more preferably at most 30 ppm, most preferably at most 10 ppm.

In addition, since ethylene glycol also contains oxygen dissolving therein, it is desirable that ethylene glycol is previously subjected to bubbling with an inert gas having an oxygen concentration of at most 5 ppm, preferably at most 3 ppm, more preferably at most 2 ppm, most preferably at most 1 ppm, and the dissolution chamber and the storage chamber are also subjected to bubbling with the inert gas as described above after slurry preparation.

It is desirable that, using a device comprising one or two interesterification reactors connected in series, the interesterification is carried out under conditions where reflux of ethylene glycol is attained, while an inert gas having an oxygen concentration of at most 50 ppm, preferably at most 10 ppm, more preferably at most 5 ppm, most preferably at most 1 ppm is made to run through the gaseous phase part and while methanol produced during the reaction is removed out of the system via a distillation tower. It is also desirable that the oxygen concentration in the gaseous phase is kept to be at most 100 ppm, preferably at most 70 ppm, more preferably at most 50 ppm, even more preferably at most 30 ppm, most preferably at most 10 ppm.

In the first-stage interesterification, the temperature may be from 180 to 250° C., preferably from 200 to 240° C.; and in the final-stage interesterification, the temperature may be generally from 230 to 270° C., preferably from 240 to 265° C. As an interesterification catalyst, a fatty acid salt or carbonate of Zn, Cd, Mg, Mn, Co, Ca or Ba, or an oxide of Pb, Zn, Sb or Ge is used. The interesterification gives a low-order condensate having a molecular weight of approximately from 200 to 500.

As one method of keeping the fluorescence intensity (B₀) of the polyester resin and the increment (Bₕ-B₀) in the fluorescence intensity upon heat treatment within the intended range as mentioned above, it is an extremely important factor to control the oxygen concentration in the gaseous phase in the material mixing chamber and the reactor within the defined range as described above and, as a result, it is possible to obtain a polyester capable of giving a shaped article having excellent transparency and stable crystallization rate and having excellent flavor retentiveness.

For the above-mentioned starting materials, i.e., dimethyl terephthalate, terephthalic acid and ethylene glycol, virgin dimethyl terephthalate and terephthalic acid derived from paraxylene, and ethylene glycol derived from ethylene can be used as a matter of course. Further, recycled materials such as dimethyl terephthalate, terephthalic acid, bishydroxyethyl terephthalate and ethylene glycol that are recycled from used PET bottles according to a chemical recycling method such as methanol decomposition or ethylene glycol decomposition can also be utilized as at least a part of the starting material. Needless-to-say, the recycled materials must be purified to have sufficient purity and quality in accordance with the intended use.

Next, the obtained low-order condensate is fed to a multi-stage liquid-phase polycondensation step. Regarding the polycondensation condition, the reaction temperature in the first-stage polycondensation is from 250 to 285° C., preferably from 260 to 280° C., and the pressure is from 100 to 10 Torr, preferably from 70 to 15 Torr; and the temperature in the final-stage polycondensation is from 265 to 290° C., preferably from 275 to 285° C., and the pressure is from 5 to 0.01 Torr, preferably from 3 to 0.2 Torr. Preferably, the pressure in the polycondensation reaction is reduced as much as possible in order that the reaction proceeds at a lower temperature for a shorter period of time. Preferably, the polycondensation reaction time is from 1 to 7 hours, and also preferably, the time for which the reaction temperature is 270° C. or higher is within 5 hours. In the case where the reaction is three-stage or more multi-stage reaction, the reaction condition for the intermediate-stage polycondensation may fall between the first-stage reaction condition and the final-stage reaction condition. Preferably, the increase in the intrinsic viscosity that is attained in each polycondensation reaction step is smoothly distributed over these steps.

It is as a matter of course that the melt polycondensation reactor must be so designed that no air could penetrate into the system, and it is important that in an periodic overhaul for periodic maintenance, the reactor is so overhauled and maintained that air penetration into the reactor during melt polycondensation under reduced pressure is prevented to the maximum level. In particular, air penetration into the reactor through sealed parts of movable members such as a stirring shaft or a pump used for transportation between reaction chambers has significant influences on the reactor, and it is desirable that the sealed part has a leak-free seal structure, and also that an inert gas having an oxygen concentration of at most 5 ppm, preferably at most 3 ppm, more preferably at most 2 ppm, most preferably at most 1 ppm is made to run around the sealed part.

It is also desirable that the two-stage and the later-stage polycondensation reactors, especially the final-stage polycondensation reactor are those of high plug-flowability in which the polyester residence is reduced and a polyester having a middle stage degree of polymerization introduced thereinto is successively polycondensed to be discharged out of it in the form of a final polycondensate. For this, it is desirable that the shape of the stirring blade is optimized and the rotation of the stirring blade is suitably set. In addition, a reactor equipped with a double-shaft stirring blade is also preferred.

For the polycondensation reaction, a single-stage polycondensation device may also be used.

A polycondensation catalyst is used for the polycondensation reaction. For the polycondensation catalyst, preferably used is at least one compound selected from Ge, Sb, Ti or Al compounds. These compounds may be added to the reaction system in the form such as powder, aqueous solution, ethylene glycol solution or ethylene glycol slurry.

Preferably, the catalyst solution or slurry is, during or after its preparation, subjected to bubbling with an inert gas having an oxygen concentration of at most 5 ppm, preferably at most 3 ppm, more preferably at most 2 ppm, most preferably at most 1 ppm, or after it is subjected to bubbling with such an inert gas, it is also desirable that an inert gas of the same type is made to run through the gaseous phase in the reaction system.

For the Ge compound, herein usable are amorphous germanium dioxide, crystalline germanium dioxide powder or slurry with ethylene glycol; a solution prepared by dissolving crystalline germanium dioxide in water under heat, and a solution prepared by adding ethylene glycol thereto followed by heating. In order to obtain the polyester resin of the invention, it is especially desirable to use a solution prepared by dissolving germanium dioxide in water under heat, or a solution prepared by adding ethylene glycol thereto followed by heating. Apart from these, examples include compounds of germanium tetroxide, germanium hydroxide, germanium oxalate, germanium chloride, germanium tetraethoxide, germanium tetra-n-butoxide, and germanium phosphite. When the Ge compound is used, then its amount is from 10 to 150 ppm, preferably from 13 to 100 ppm, more preferably from 15 to 70 ppm in terms of the residual Ge amount in the polyester resin.

When germanium dioxide is used as the catalyst, it is desirable that the content of sodium or potassium or the overall content of sodium and potassium in germanium dioxide is at most 100 ppm, preferably at most 50 ppm, more preferably at most 10 ppm. Also preferably, the heat loss of germanium dioxide is from 1.5 to 15.0%, more preferably from 1.5 to 4.5%, even more preferably from 1.5 to 4.0%.

The Ti compound includes tetraalkyl titanates such as tetraethyl titanate, tetraisopropyl titanate, tetra-n-propyl titanate, tetra-n-butyl titanate, and their partial hydrolyzates; titanyl acetate; titanyl oxalate compounds such as titanium oxalate, ammonium titanyl oxalate, sodium titanyl oxalate, potassium titanyl oxalate, calcium titanyl oxalate, strontium titanyl oxalate; titanium trimellitate, titanium sulfate, titanium chloride, titanium halide hydrolyzates, titanium bromide, titanium fluoride, potassium hexafluorotitanate, ammonium hexafluorotitanate, cobalt hexafluorotitanate, manganese hexafluorotitanate, titanium acetylacetonate, composite oxide of titanium and silicon or zirconium, and reaction products of titanium alkoxide and phosphorus compound. The Ti compound is added to the reaction system so that the residual Ti content in the produced polymer is from 0.1 to 50 ppm.

The Sb compound includes antimony trioxide, antimony acetate, antinomy tartrate, potassium antimony tartrate, antimony oxychloride, antimony glycolate, antimony pentoxide, triphenylantimony.

The Sb compound is added to the reaction system so that the residual Sb content in the produced polymer is from 50 to 250 ppm.

The Al compound specifically includes carboxylates such as aluminium formate, aluminium acetate, basic aluminium acetate, aluminium propionate, aluminium oxalate, aluminium acrylate, aluminium laurate, aluminium stearate, aluminium benzoate, aluminium trichloroacetate, aluminium lactate, aluminium citrate, aluminium salicylate; inorganic acid salts such as aluminium chloride, aluminium hydroxide, aluminium hydroxide chloride, polyaluminium chloride, aluminium nitrate, aluminium sulfate, aluminium carbonate, aluminium phosphate, aluminium phosphonate; aluminium alkoxides such as aluminium methoxide, aluminium ethoxide, aluminium n-propoxide, aluminium iso-propoxide, aluminium n-butoxide, aluminium t-butoxide; aluminium chelate compounds such as aluminium acetylacetonate, aluminium acetylacetate, aluminium ethylacetoacetate, aluminium ethylacetacetate diisopropoxide; organoaluminium compounds such as trimethylaluminium, triethylaluminium, and their partial hydrolyzates; and aluminium oxide. Of those, preferred are carboxylates, inorganic acid salts and chelate compounds; and more preferred are basic aluminium acetate, aluminium lactate, aluminium chloride, aluminium hydroxide, aluminium hydroxide chloride, polyaluminium chloride, and aluminium acetylacetonate. The Al compound is added to the reaction system so that the residual Al content in the produced polymer is from 5 to 200 ppm.

In the method for producing the polyester resin of the invention, an alkali metal compound or an alkaline earth metal compound may also be used. The alkali metal and the alkaline earth metal are preferably at least one selected from Li, Na, K, Rb, Cs, Be, Mg, Ca, Sr and Ba. More preferably used is such an alkali metal or a compound thereof. When an alkali metal or a compound thereof is used, more preferred is Li, Na or K. The alkali metal and alkaline earth metal compounds include, for example, salts with the metal of saturated aliphatic carboxylic acids such as formic acid, acetic acid, propionic acid, butyric acid, oxalic acid; salts of unsaturated aliphatic carboxylic acids such as acrylic acid, methacrylic acid; salts of aromatic carboxylic acids such as benzoic acid; salts of halogenocarboxylic acids such as trichloroacetic acid; salts of hydroxycarboxylic acids such as lactic acid, citric acid, salicylic acid; salts of inorganic acids such as carbonic acid, sulfuric acid, nitric acid, phosphoric acid, phosphonic acid, hydrogencarbonate, hydrogenphosphate, hydrogen sulfide, sulfurous acid, thiosulfuric acid, hydrochloric acid, hydrobromic acid, chloric acid, bromic acid; salts of organic sulfonic acids such as 1-propanesulfonic acid, 1-pentanesulfonic acid, naphthalenesulfonic acid; salts of organic sulfuric acids such as laurylsulfate; alkoxides such as methoxide, ethoxide, n-propoxide, iso-propoxide, n-butoxide, tert-butoxide; chelate compounds such as acetylacetonate; hydrides, oxides, and hydroxides.

The alkali metal compound or the alkaline earth metal compound is added to the reaction system in the form of powder, aqueous solution or ethylene glycol solution. The alkali metal compound or the alkaline earth metal compound is added so that the residual element content in the produced polymer is from 1 to 50 ppm.

The polyester resin of the invention may contain a metal compound containing at least one element selected from the group consisting of silicon, manganese, iron, cobalt, zinc, gallium, strontium, zirconium, tin, tungsten, lead.

The metal compound include a salt of the element, for example, saturated aliphatic carboxylates such as acetates; unsaturated aliphatic carboxylates such as acylates; aromatic carboxylates such as benzoates; halogenocarboxylates such as trichloroacetates; hydroxycarboxylates such as lactates; inorganic acid salts such as carbonates; organic sulfonates such as 1-propanesulfonates; organic sulfates such as lauryl sulfates; oxides, hydroxides, chlorides, alkoxides, and chelate compounds with acetylacetonates. The metal compound is added to the reaction system in the form of powder, aqueous solution, ethylene glycol solution or ethylene glycol slurry. The metal compound is added so that the residual element content per ton of the produced polymer is from 0.05 to 3.0 mols. The metal compound may be added in any stage of the polyester production process mentioned above.

In combination with the above-described polymerization catalyst, various P compounds may also be used. Of P compounds, especially preferred for use herein are phosphorus compounds having a phenol moiety in its molecule.

Not specifically limited, the P compound for use herein is preferably one or more selected from the group consisting of phosphonic acid compounds, phosphinic acid compounds, phosphine oxide compounds, phosphonous acid compounds, phosphinous acid compounds, phosphinic acid compounds. Of those, more preferred for use herein are one or more phosphonic acid compounds. Of such phosphorus compounds, even more preferred for use herein are those having an aromatic ring structure.

Specific examples of the P compound for use in the invention include phosphoric acid; phosphoric acid derivatives such as trimethyl phosphate, triethyl phosphate, tributyl phosphate, triphenyl phosphate, monomethyl phosphate, dimethyl phosphate, monobutyl phosphate, dibutyl phosphate; phosphorous acid; phosphorous acid derivatives such as trimethyl phosphite, triethyl phosphite, tributyl phosphite; phosphonic acid derivatives such as methylphophonic acid, dimethyl methylphosphate, dimethyl ethylphosphate, dimethyl ethylphosphate, dimethyl phenylphosphate, diethyl phenylphosphate, diphenyl phenylphosphate; phosphinic acid derivatives such as diphenylphosphinic acid, methyl diphenylphosphinate, phenyl diphenylphosphinate, phenylphosphinic acid, methyl phenylphosphinate, phenyl phenylphosphinate.

Also usable herein are phosphorus compounds having a phenol moiety in its molecule, for example, p-hydroxyphenylphosphonic acid, dimethyl p-hydroxyphenylphosphonate, diethyl p-hydroxyphenylphosphonate, diphenyl p-hydroxyphenylphosphonate, bis(p-hydroxyphenyl)phosphinate, methyl bis(p-hydroxyphenyl)phosphinate, phenyl bis(p-hydroxyphenyl)phosphinate, p-hydroxyphenylphenylphosphinic acid, methyl p-hydroxyphenylphenylphosphinate, phenyl p-hydroxyphenylphenylphosphinate, p-hydroxyphenylphosphinic acid, methyl p-hydroxyphenylphosphinate, phenyl p-hydroxyphenylphosphinate, bis(p-hydroxyphenyl)phosphine oxide, tris(p-hydroxyphenyl)phosphine oxide, bis(p-hydroxyphenyl)methylphosphine oxide.

Also usable are ethyl benzylphosphonate, benzylphosphonic acid, ethyl (9-anthryl)methylphosphonate, ethyl 4-hydroxybenzylphosphonate, ethyl 2-methylbenzylphosphonate, phenyl 4-chlorobenzylphosphonate, methyl 4-aminobenzylphosphonate, ethyl 4-methoxybenzylphosphonate, diethyl 3,5-di-tert-butyl-4-hydroxybenzylphosphonate.

Also usable are metal salt compounds with phosphorus, for example, lithium[ethyl 3,5-di-tert-butyl-4-hydroxybenzylphosphonate], sodium[ethyl 3,5-di-tert-butyl-4-hydroxybenzylphosphonate], potassium[ethyl 3,5-di-tert-butyl-4-hydroxybenzylphosphonate], magnesiumbis[ethyl 3,5-di-tert-butyl-4-hydroxybenzylphosphonate], magnesiumbis[3,5-di-tert-butyl-4-hydroxybenzylphosphonic acid], calciumbis[methyl 3,5-di-tert-butyl-4-hydroxybenzylphosphonate], calciumbis[3,5-di-tert-butyl-4-hydroxybenzylphosphonic acid], berylliumbis[methyl 3,5-di-tert-butyl-4-hydroxybenzylphosphonate], strontiumbis[ethyl 3,5-di-tert-butyl-4-hydroxybenzylphosphonate], bariumbis[phenyl 3,5-di-tert-butyl-4-hydroxybenzylphosphonate].

These may be used either singly or as combined. The P compound is added to the reaction system in any stage of the above-mentioned polyester production process so that the residual P content in the produced polymer is from 1 to 1000 ppm.

Also preferably, a hindered phenol-type antioxidant is added.

Any known hindered phenol-type antioxidant may be used herein, including, for example, pentaerythritol tetrakis[3-(3,5-di-tert-butyl-4-hyd3-(3,5-di-tert-butyl-4-hydroxyphenyl)propionate], 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, 3,9-bis{2-[3-(3-tert-butyl-4-hydroxy-5-methy3-(3-tert-butyl-4-hydroxy-5-methylphenyl)propionyloxy)-1,1-dimethylethyl]-2,4,8,10-tetroxaspiro[5,5]undecane, 1,3,5-tris(4-tert-butyl-3-hydroxy-2,6-dimethylbenzene)isophthalic acid, triethylene glycol bis[3-(3-tert-butyl-5-methyl-4-hydrox 3-(3-tert-butyl-5-methyl-4-hydroxyphenyl)propionate], 1,6-hexanediol bis[3-(3,3-(3,5-di-tert-butyl-4-hydroxyphenyl)propionate], 2,2-thio-diethylenebis[3-(3,5-di-tert-butyl-4-hydroxyph3-(3,5-di-tert-butyl-4-hydroxyphenyl)propionate), octadecyl 3-(3,5-di-tert-butyl-4-hydroxyphenyl)propionate, ethyl 3,5-di-tert-butyl-4-hydroxybenzylphosphonate, methyl 3,5-di-tert-butyl-4-hydroxybenzylphosphonate, isopropyl 3,5-di-tert-butyl-4-hydroxybenzylphosphonate, phenyl 3,5-di-tert-butyl-4-hydroxybenzylphosphonate, octadecyl 3,5-di-tert-butyl-4-hydroxybenzylphosphonate, and 3,5-di-tert-butyl-4-hydroxybenzylphosphonic acid.

In this case, the hindered phenol-type antioxidant may be bonded to the polyester, and the amount of the hindered phenol-type antioxidant in the polyester resin is preferably at most 1% by weight of the polyester resin. This is because, if the amount is over 1% by weight, then the resin may be colored; and even if it is over 1% by weight, the ability of the antioxidant to improve the melt stability of the resin is saturated. Preferably, the amount is from 0.02 to 0.5% by weight.

The above-mentioned metal compound, stabilizer and antioxidant may be added to the reaction system in the form of powder, aqueous solution, ethylene glycol solution or ethylene glycol slurry.

Preferably, the solution or slurry is, during or after its preparation, subjected to bubbling with an inert gas having an oxygen concentration of at most 50 ppm, preferably at most 10 ppm, more preferably at most 5 ppm, most preferably at most 1 ppm, or after it is subjected to bubbling with such an inert gas, it is also desirable that an inert gas of the same type is made to run through the gaseous phase in the reaction system.

The melt polycondensate polyester obtained in the manner as described above is formed into chips after the process of melt polycondensation, and therefore it must be kept in melt at a temperature as low as possible and for a period of time as short as possible before it is extruded out through fine orifices. Regarding the condition under which the polyester is kept in melt after the process of melt polycondensation, it is desirable that the temperature is not lower than its melting point but not higher than 290° C., preferably at most 285° C., more preferably at most 280° C., and that the time is within 20 minutes, preferably within 15 minutes, more preferably within 10 minutes, even more preferably within 5 minutes. Accordingly, it is necessary that the piping arrangement, etc. is so designed that, after produced through melt polycondensation, the polyester can be immediately cooled and chipped. If the residence of the polyester is made at a high temperature of 290° C. or higher for a long period of time of 20 minutes or longer, then its fluorescence intensity (B₀) could not be at most 20 and the fluorescence intensity increment (Bₕ-B₀) after the heat treatment could not be at most 30 and, in addition, this may cause the above-mentioned problem since the crystallization rate of the obtained shaped article is too high and also this may cause another problem that the content flavor retentiveness of the shaped article may be poor. When the polyester resin is left in air for a long period of time even at a temperature not higher than its melting point, then, as the case may be, its fluorescence intensity (B₀) could not be at most 20 and the fluorescence intensity increment (Bₕ-B₀) after the heat treatment could not be at most 30. Accordingly, it is desirable that the polyester resin is cooled to about 100° C. or lower as soon as possible according to the method mentioned below.

The melt polycondensate polyester obtained in the manner as described above is, after the process of melt polycondensation, extruded out through fine orifices into cooled water having a chemical oxygen demand (COD) of preferably at most 2.0 mg/liter, more preferably at most 1.5 mg/liter, even more preferably at most 1.0 mg/liter, and cut into chips therein; or after it is once extruded out in air, then immediately cut into chips in cold water having the same COD as described above while cooled therein. The lower limit of COD is not specifically limited, but from the practicable viewpoint, it may be at least 0.01 mg/liter. If it is lower than 0.01 mg/liter, then the equipment cost may be high and it may be impossible to economically efficiently cut the polyester into chips. On the other hand, if the COD of the cooling water to be used in the chipping step is more than 2.0 mg/liter, then the fluorescence intensity (B₀) of the polyester resin could not be at most 20 and the fluorescence intensity increment (Bₕ-B₀) upon the heat treatment could not be at most 30 and, in addition, this may cause the above-mentioned problem since the crystallization rate of the obtained shaped article is too high and this may cause another problem that the content flavor retentiveness of the shaped article may be poor.

An example of the method for reducing COD of cooling water for use in the chipping step is described, but the invention should not be construed as being limited thereto.

For reducing the COD of fresh water to be introduced into the chipping step, a device for COD reduction is disposed in at least one or more sites in the process from taking industrial water for the chipping step to transferring it into the chipping step. If desired, such a COD-reducing device may also be disposed in at least one or more sites in the process from discharging the waste water from the chipping step to again returning it to the chipping step. The COD-reducing device includes those of ultrafiltration, reverse-osmotic filtration, flocculation deposition, activated sludge treatment, activated charcoal treatment or UV irradiation.

From the aspects of the shape and fusion of the chips, the temperature of the water for cooling the chips is preferably from about 4° C. to about 40° C.

Preferably, cooling water for use in the chipping step of the invention satisfies at least one of the following relationships (1) to (4) in respect of the sodium content (N), the magnesium content (M), the silicon content (S) and the calcium content (C). More preferably, cooling water satisfying all of these is used in chipping the melt polycondensate polyester of the invention.
N≦1.0 (ppm) (1)
M≦0.5 (ppm) (2)
S≦2.0 (ppm) (3)
C≦1.0 (ppm) (4)

The sodium content (N) of the cooling water is preferably N≦0.5 (ppm), more preferably N≦0.1 ppm. The magnesium content (M) of the cooling water is preferably M≦0.3 (ppm), more preferably M≦0.1 ppm. The silicon content (S) of the cooling water is preferably S≦0.5 (ppm), more preferably S≦0.3 ppm. The calcium content (C) of the cooling water is preferably C≦0.5 (ppm), more preferably C≦0.1 ppm.

Though not specifically limited, the lowest value of the sodium content (N), the magnesium content (M), the silicon content (S) and the calcium content (C) of the cooling water may be as follows from the practical aspect: N≧0.001 ppm, M≧0.001 ppm, S≧0.02 ppm, and C≧0.001 ppm. In order to further lower the content to a value lower than the lower limit, a great investment in equipment is necessary and, in addition, the running cost is extremely high, and hence economically efficient production may be hardly attained therewith.

If cooling water not falling within the above-mentioned condition is used, then it is unfavorable since the metal-containing compound existing therein adheres to the surface of the polyester resin chips and the crystallization rate of the resulting polyester resin is considerably high and its fluctuation becomes large. The metal content of industrial water significantly fluctuates throughout the year and the metal content adhering to the polyester resin might vary according to the fluctuation, and therefore if such industrial water is used for cooling the chips in the invention, in place of the cooling water that satisfies at least one of the above (1) to (4), then the transparency of the shaped article formed from the polyester resin is poor and the transparency fluctuation becomes considerably large. Preferably, the cooling water for use herein satisfies all the above relationships (1) to (4).

When the melt polycondensate chips cooled by the use of cooling water that does not fall within the above-mentioned conditions are subjected to solid-phase polymerization, then the metal-containing substance having adhered to the surface of the chips in the chipping step and having been brought into the solid-phase polymerization reactor along with the chips adheres to the wall of the solid-phase polymerization reactor with a part of the surface layer of the polyester resin chips, and this is heated for a long period of time at a high temperature of about 170° C. or higher to give high-metal-content scale deposited on the reactor wall. This may peel off to mix in the polyester resin chips, and may cause a problem that it serves as a foreign substance in the shaped articles such as bottles and lowers the commercial value of the products.

In producing sheets, the scale may clog a melt polymer filter during the sheet-forming process, and therefore this may cause a problem that the filtration pressure may greatly increase and the operability and the productivity may be deteriorated.

A method for controlling the sodium content, the magnesium content, the silicon content and the calcium content of the cooling water for chips to fall within the ranges as described above is shown below, but the invention should not be construed as being limited thereto.

For reducing sodium, magnesium, calcium and silicon in the cooling water, a device for removing sodium, magnesium, calcium and silicon is disposed in at least one or more sites in the process up to the stage where industrial water is fed to the chips-cooling step. For removing granular silicon dioxide and clay minerals such as aluminosilicate, a filter may be disposed. The device for removing sodium, magnesium, calcium and silicon includes an ion-exchange device, an ultrafiltration device, and a reverse-osmotic membrane device.

When external water running into the system is used as the chips-cooling water, then it is desirable that the amount of the particles in the water having a particle size of from 1 to 25 μm is reduced to at most 50000 particles/10 ml. Preferably, the amount of the particles having a particle size of from 1 to 25 μm in the cooling water is at most 10000 particles/10 ml, more preferably at most 1000 particles/10 ml. Though not specifically limited, the amount of the particles having a particles size of larger than 25 μm in the cooling water to be introduced into the system is preferably at most 2000 particles/10 ml, more preferably at most 500 particles/10 ml, even more preferably at most 100 particles/10 ml, still more preferably at most 10 particles/10 ml.

A method for controlling the amount of the particles having a particle size of from 1 to 25 μm that may be in the cooling water to be introduced into the chips-cooling step to a range of at most 50000 particles/10 ml is described below, but the invention should not be construed as being limited thereto.

For reducing the number of the particles in the water to at most 50000 particles/10 ml, a device for removing particles is disposed in at least one or more sites in the process from collecting natural water such as industrial water to transferring it to the chipping step. Preferably, a device for removing particles is disposed between the water-collecting mouth at which natural water is collected and the start of the chipping step, and the amount of the particles having a particle size of from 1 to 25 μm in the water to be fed to the chipping step is reduced to at most 50000 particles/10 ml. The device for removing particles includes a filter device, a membrane filtration device, a flocculation tank, a centrifugal device, a bubbles-associated processor. For example, the filter device includes a belt filter system, a bag filter system, a cartridge filter system, a centrifugal filter system. Of those, a belt filter system, a centrifugal filter system and a bag filter system are preferred for continuous filtration process. In the belt filter system, the filter may be formed of paper, metal or cloth. For making efficient the removal of particles and the flow of water being processed through it, the filter pore size may be from 5 to 100 μm, preferably from 10 to 70 μm, more preferably from 15 to 40 μm.

From the viewpoint of improving the economical advantage and the productivity, the chips-cooling water is preferably recycled in the process. In the step of recycling the cooling water, a filter, a temperature controller and a device for removing impurities such as acetaldehyde may be disposed. In addition, devices for removing the particles as well as sodium, magnesium, calcium and silicon may also be disposed.

During the chipping in the invention, it is desirable that the dissolved oxygen concentration in the cooling water that is taken in from the outside and used in the chipping step is kept to be at most about 45 cm³/liter.

In addition, the cooling water for use herein preferably satisfies log Y≦1.78-8.23×10⁻³ X, more preferably log Y≦1.73-8.23×10⁻³ X, even more preferably log Y≦1.68-8.23×10⁻³ X, most preferably log Y≦1.63-8.23×10⁻³ X, wherein Y (cm³/liter) indicates the dissolved oxygen concentration in the cooling water, and X (° C.) indicates the temperature of the cooling water.

In general, the dissolved oxygen concentration in water is about 38.0 cm³/liter under 1 atmosphere at 10° C., and about 26.0 cm³/liter at 30° C. However, when industrial water having a low temperature is used, oxygen may dissolve therein to a degree over the solubility thereof in a supersaturated condition, or oxygen more than the range may dissolve in water at the bottom of the storage tank owing to the pressure by the self weight of water. In particular, when the chips-cooling water is recycled for reuse as in the above, then it can be considered that impurities, for example, the low-molecular weight compounds such as monomers and oligomers dissolved in the cooling water as well as other organic compounds from the outside of the system may be oxidized owing to the influence of the supersaturated oxygen in water and, as a result, the residual foreign taste and the foreign odor may increase. In addition, it can be considered that oxygen may penetrate into the resin chips and the chips may emit fluorescence.

An example of the method for controlling the dissolved oxygen concentration in water to be within the range as described above is shown below, but the invention should not be construed as being limited thereto. For controlling the dissolved oxygen concentration in water that is used for cooling water, it is desirable that a suitable device for reducing the dissolved oxygen is disposed in at least one or more sites in the process up to the stage where the water as the cooling water is fed to the system; for controlling the dissolved oxygen concentration in the water in the cooling water tank, it is desirable that the device of the type is disposed in at least one or more sites in the process of from discharging the water out of the cooling water tank to again returning the circulating water to the cooling water tank; and for controlling the dissolved oxygen concentration in the cooling chamber, it is desirable that the device of the type is disposed inside the cooling chamber. As the device for reducing the dissolved oxygen, herein employable is any of a device for degassing and introducing an inert gas such as nitrogen gas or carbon dioxide gas, a vacuum thermal degassing device, and a thermal degassing device. These devices may also be used for water treatment described hereinunder.

In the case where employed is the system in which after melt polycondensation, the polyester melt is extruded out through the orifices of a die into air, and then cut into chips while cooled with cooling water, it is also desirable that an inert gas jet may be applied to the polymer melt that runs out through the orifices of a die so that no oxygen could adhere to the high-temperature resin until it is contacted with cooling water. The inert gas jet may have an oxygen concentration of at most 5 ppm, preferably at most 3 ppm, more preferably at most 2 ppm, most preferably at most 1 ppm.

When the system of spraying a cooling water shower over the resin melt for cooling is employed, then the cooling water dissolves oxygen and the dissolved oxygen concentration therein increases. In this case, therefore, it is desirable that the oxygen concentration in the gaseous phase in the cooling step is controlled to be at most 500 ppm, preferably at most 300 ppm, more preferably at most 100 ppm, even more preferably at most 50 ppm, most preferably at most 10 ppm, and its fluctuation range is controlled to be within 30%, preferably within 20%. For the method of controlling the oxygen concentration in the gaseous phase in the cooling step, it is desirable that the inert gas jet applied to the polymer melt is directly made to run also through the cooling step.

In the method for producing the polyester resin of the invention, it is also desirable that the water adhesion to the melt polycondensate polyester resin chips obtained in the chipping step is preferably at most 3000 ppm, more preferably at most 2500 ppm, even more preferably at most 2000 ppm. If the water adhesion is over 3000 ppm and when the polyester-resin chips of the type are dried or subjected to solid-phase polymerization, then this may cause problems that the fluorescence intensity (B₀) of the resin could hardly be at most 20 and the fluorescence intensity increment (Bₕ-B₀) upon the heat treatment could hardly be at most 30. The adhering water is measured by the use of a minor water content meter by Mitsubishi Chemical (Model, CA-06/VA-06). For controlling the adhering water to be at most 3000 ppm, often employed is a centrifugal method, a shaking method or a hot gas blasting method in removing water from chips. The above-described adhering water can be attained by tightening the operational condition in these methods.

When the melt polycondensate resin is directly used for shaping, then the polyester chips that are so controlled to have an adhering water content of at most 3000 ppm after the chipping step are fed to a drying step and are dried therein. In the process of from cooling to drying the chips, it is desirable that the oxygen concentration in the gaseous phase is controlled to be at most 100 ppm, preferably at most 80 ppm, more preferably at most 50 ppm, even more preferably at most 30 ppm, most preferably at most 10 ppm.

The drying temperature is from about 50° C. to about 150° C., preferably from about 60° C. to about 140° C.; and the drying time is from about 3 hours to about 30 hours, preferably from about 4 hours to 20 hours, more preferably from 4 hours to 15 hours.

For the drying gas, preferred is an inert gas having a dew point of not higher than −25° C., and having an oxygen concentration of at most 100 ppm, preferably at most 80 ppm, more preferably at most 50 ppm, even more preferably at most 30 ppm, most preferably at most 10 ppm.

The inert gas to be used in the above may be nitrogen gas, carbon dioxide gas or helium gas; but nitrogen gas is most preferred.

However, when an inert gas is unemployable for some economical reason, then dried air having a dew point not higher than −25° C., and having an SOx content of at most about 0.01 ppm and an NOx content of at most about 0.01 ppm may be used with drying conditions of at a temperature of from about 50° C. to about 100° C. for a period of time of from about 3 hours to about 10 hours. In this case, it is necessary to more severely control the other condition so as to prevent the fluorescence intensity of the resin from increasing. For removing SOx and NOx from air, employable is an activated charcoal filter or a filter that contains metal particles having a catalytic activity.

If various drying conditions do not fall within the above ranges, then the fluorescence intensity (B₀) of the polyester resin may be over 20 and the fluorescence intensity increment (Bₕ-B₀) upon the heat treatment may be over 30 and there is a considerably high possibility that this may cause problems.

It is also important that the drying device is free from dead space where shape-deficient products of chips and fines may stay for a long period of time. If the device has a dead space, then this may cause problems that the chips and the like staying there for a long period of time may have a fluorescence intensity (B₀) of higher than 20 and the fluorescence intensity increment (Bₕ-B₀) upon the heat treatment may be over 30.

Preferably, the drying device is so designed that the resin introduced thereinto is discharged successively. When the mean residence time of the resin in the device is represented by t, then it is desirable that 95% by weight, preferably 98% by weight, more preferably 99% by weight of the resin is discharged out of the device within a period of time of from 0.9 t to 1.1 t. As the device of such type, preferred are a vertical hopper-type drier which is so designed that the apex angle of the inversed-cone part at the bottom thereof at which an outlet mouth for discharging the dried chips therethrough is disposed is appropriately defined depending on the angle of repose of the chips and a baffle cone is disposed therein, and a horizontal drier with a transportation paddle or a disc disposed at the rotary shaft thereof so as to increase the plug-flowability.

When the dried resin could not be smoothly and successively discharged out of the device or when the device has a dead space, then the chips having stayed in the device for a long period of time suffer from a greater thermal hysteresis. If such chips are mixed in the resin product, then the fluorescence intensity (B₀) of the resin product may be over 20 and the fluorescence intensity increment (Bₕ-B₀) after the heat treatment may be over 30 and there is a considerably high possibility that this may cause problems.

Next, in solid-phase polymerization of the melt polycondensate polyester chips obtained as described above, it is desirable that the chips are once transported and temporally stored in a chip tank in an inert gas atmosphere having an oxygen concentration of at most 100 ppm, preferably at most 50 ppm, more preferably at most 30 ppm, most preferably at most 10 ppm, and then subjected to continuous solid-phase polymerization so as to further lower the acetaldehyde content of the polyester and to increase the intrinsic viscosity thereof after the melt polycondensation process. It is also desirable that the polyester to be polymerized in a solid phase is first subjected to precrystallization in an inert gas or in water vapor or in a water vapor-containing inert gas atmosphere, and then dried to have a water content of at most about 10 ppm (the precrystallization/drying will be hereinafter collectively referred to as precrystallization). It is considered that the polyester is precrystallized before completely dried, whereby oxygen is prevented from penetrating into the resin and therefore the resin is hardly influenced by oxygen in the subsequent drying step.

The precrystallization temperature is preferably 180° C. or lower, more preferably 175° C. or lower, even more preferably 170° C. or lower; and the lower limit of the temperature is preferably 100° C. or higher, more preferably 120° C. or higher. The time of the precrystallization step is preferably at most 5 hours, more preferably at most 4 hours, even more preferably at most 3.5 hours; and the lower limit of the time is at least 0.5 minutes, more preferably at least 1 minute. When the precrystallization temperature is high, then the time must be shortened; but when the time is long, then the temperature must be low. For example, the time is preferably about 2 hours at 180° C., about 3 hours at 160° C., and about 3.5 hours at 150° C.

In this stage, the oxygen concentration in the inert gas atmosphere is preferably at most 50 ppm, more preferably at most 40 ppm, even more preferably at most 30 ppm, still more preferably at most 20 ppm, most preferably at most 10 ppm.

Next, the solid-phase polymerization is carried out in an inert gas atmosphere having an oxygen concentration of preferably at most 50 ppm, more preferably at most 40 ppm, even more preferably at most 30 ppm, most preferably at most 20 ppm. After the solid-phase polymerization, the chips are cooled to a temperature of about 60° C. or lower in the same inert gas atmosphere as in the above. Regarding the solid-phase polymerization temperature, its upper limit is preferably 220° C. or lower, more preferably 215° C. or lower, even more preferably 210° C. or lower, and its lower limit is preferably 190° C. or higher, more preferably 195° C. or higher. Though depending on the intended degree of polymerization, the time of the solid-phase polymerization is preferably at most 30 hours, more preferably at most 15 hours, even more preferably at most 10 hours, still more preferably at most 8 hours, most preferably at most 7 hours. When the temperature is high, then the time of the solid-phase polymerization is shortened. Specifically, when the solid-phase polymerization is carried out for a long period of time, then the temperature must be set low, and excess temperature and time hysteresis must be avoided. For standard reference, the time is at most about 20 hours at 210° C., and at most about 35 hours at 205° C. It is necessary that the degree of pressure reduction is controlled or the inert gas flow rate is increased or the specific surface area of the polyester chips is increased so that the solid-phase polymerization could be completed at a relatively low temperature for a short period of time.

When the oxygen concentration in the inert gas in the precrystallization and the solid-phase polymerization is over 50 ppm and when the treatment is effected at an excessively-elevated temperature for an excessively-prolonged period of time, then it is unfavorable since the fluorescence intensity (B₀) of the resin may be over 20 and the fluorescence intensity increment (Bₕ-B₀) after the heat treatment may be over 30.

The time for storage of the melt polycondensate chips before solid-phase polymerization is at most 10 days even under the above-mentioned condition, and it is desirable that the chips are processed within a period of time as short as possible. Solid-phase polymerization of the melt polycondensate polyester after left in air for a long period of time must be avoided.

However, when the melt polycondensation device and the solid-phase polymerization device are connected in series and driven continuously, then the melt polycondensate polymer may be stored in air within one day and the solid-phase polymerization of the thus-stored polyester may not have any negative influence on the fluorescence-emitting characteristics of the polyester obtained after the solid-phase polymerization.

The inert gas discharged out of each step in the invention may be recycled by removing the compounds existing therein, for example, a solid such as monomer, water or a volatile substance such as ethylene glycol or aldehyde, in a suitable device, or by mixing it with a fresh inert gas, or by contacting it with an oxygen scavenger to thereby reduce the oxygen concentration in the inert gas as in the above.

Further, in the precrystallization and the solid-phase polymerization, it is necessary to reduce the frequency of long-term residence of the polyester chips. If the polyester chips stay for long in the system, then the chips may contain those portions having suffered from superfluous thermal hysteresis and, as a result, the fluorescence intensity (B₀) of the chips may be over 20 and the fluorescence intensity increment (Bₕ-B₀) after the heat treatment may be over 30. For this, it is important that the precrystallization device and the solid-phase polymerization device are free from dead space where shape-deficient products of chips and fines may stay for a long period of time. Preferably, the precrystallization device and the solid-phase polymerization device are so designed that the resin introduced thereinto is discharged successively. When the mean residence time of the resin in the devices is represented by t, then it is desirable that 95% by weight, preferably 98% by weight, more preferably 99% by weight of the resin is discharged out of the devices within a period of time of from 0.9 t to 1.1 t. As the precrystallization device, those mentioned above are preferably used. As the solid-phase polymerization device, preferred is a vertical hopper-type solid-phase polymerization reactor which is so designed that the apex angle of the inversed-cone part at the bottom thereof at which an outlet mouth for discharging the solid-phase-polymerized chips therethrough is disposed is appropriately defined depending on the angle of repose of the chips and that an accessory device such as a baffle cone is disposed around the outlet of the chips so as to prevent free running of the chips through the outlet.

When the chips are not smoothly successively discharge out of the device or when the device has a dead space, then the chips having stayed therein for a long period of time suffer from greater thermal hysteresis. If such chips are mixed in, then the fluorescence intensity (B₀) of the chips may be over 20 and the fluorescence intensity increment (Bₕ-B₀) after the heat treatment may be over 30 and there is a considerably high possibility that this may cause problems.

The inert gas to be used in the above includes nitrogen gas, carbon dioxide gas and helium gas, and nitrogen gas is most preferred.

The intrinsic viscosity of the polyester resin of the invention, especially of the polyester resin comprising ethylene terephthalate as a main repetitive unit thereof may be from 0.55 to 2.00 dl/g, preferably from 0.60 to 1.50 dl/g, more preferably from 0.65 to 1.00 dl/g, most preferably from 0.65 to 0.90 dl/g. If the intrinsic viscosity of the polyester resin is lower than 0.55 dl/g, then the mechanical properties of the shaped article obtained from the resin are poor. If, however, the intrinsic viscosity of the polyester resin is larger than 2.00 dl/g, then the resin temperature upon melting in a shaping machine is increased to make thermal decomposition vigorous and, as a result, this causes problems such that free low-molecular weight compounds that have negative influences on the flavor retentiveness increase or the shaped articles become yellowed.

The intrinsic viscosity of the polyester resin of the invention, especially of the polyester resin comprising 1,3-propylene terephthalate as a main repetitive unit thereof may be from 0.50 to 2.00 dl/g, preferably from 0.55 to 1.50 dl/g, more preferably from 0.60 to 1.00 dl/g. If the intrinsic viscosity of the polyester resin is lower than 0.50 dl/g, then it is problematic in that the elasticity recovery and durability of the fibers obtained from the resin become poor. The upper limit of the intrinsic viscosity is 2.0 dl/g. If the intrinsic viscosity is higher than the limit, the resin temperature is increased during melt spinning to make thermal decomposition vigorous and, as a result, this causes problems such that the molecular weight is greatly decreased and the resin becomes yellowed.

It is desirable that the increment in the color b value of the polyester resin of the invention, after heat-treated at 180° C. for 10 hours, is at most 4, more preferably at most 3.5, even more preferably at most 3.0, most preferably at most 2.0. If the increment in the color b value after the heat treatment is larger than 4, then it is problematic in that the color tone of the shaped article and the like obtained from the resin becomes markedly yellowed.

It is desirable that the density of the chips of the polyester resin of the invention, especially the density of the chips of the polyester resin comprising ethylene terephthalate as a main repetitive unit thereof and having been crystallized or subjected to solid-phase polymerization treatment is at least 1.37 g/cm³, preferably from 1.38 to 1.43 g/cm³, more preferably from 1.39 to 1.42 g/cm³.

The dialkylene glycol content copolymerized in the polyester resin of the invention is preferably from 0.5 to 7.0 mol %, more preferably from 1.0 to 6.0 mol %, even more preferably from 1.0 to 5.0 mol % with respect to the glycol component that constitute the polyester resin. If the dialkylene glycol content is larger than 7.0 mol %, then it is unfavorable since the heat stability of the resin becomes poor and the reduction in the molecular weight during shaping becomes greater and, in addition, the increase in the aldehyde content becomes greater. On the other hand, in order for producing the polyester resin having a dialkylene glycol content of smaller than 0.5 mol %, uneconomical production conditions must be selected for the interesterification condition, the esterification condition or the polycondensation condition, and it is not economically sensible. The “dialkylene glycol copolymerized in the polyester resin” as referred to herein means: when the polyester resin comprises ethylene terephthalate as a main constitutive unit thereof, diethylene glycol (hereinafter abbreviated to DEG) copolymerized with the polyester resin, among by-product diethylene glycol formed from ethylene glycol, which is a glycol, during the resin production; and when the polyester resin comprises 1,3-propylene terephthalate as a main constitutive unit thereof, di(1,3-propylene glycol) (hereinafter abbreviated to DPG)copolymerized with the polyester resin, among by-product di(1,3-propylene glycol) (or bis(3-hydroxypropyl) ether) formed from 1,3-propylene glycol, which is a glycol, during the resin production.

The content of the diethylene glycol copolymerized in the polyester resin of the invention, especially that in the polyester resin comprising ethylene terephthalate as a main repetitive unit thereof is from 1.0 to 5.0 mol %, preferably from 1.3 to 4.5 mol %, more preferably from 1.5 to 4.0 mol % with respect to the glycol component that constitute the polyester resin. If the diethylene glycol content is larger than 5.0 mol %, then it is unfavorable since the heat stability of the resin becomes poor so that the reduction in the molecular weight of the resin during shaping becomes greater or that the increase in the acetaldehyde content or the formaldehyde content becomes greater. On the other hand, if the diethylene glycol content is smaller than 1.0 mol %, then the transparency of the obtained shaped article becomes poor.

It is desirable that the content of aldehydes such as acetaldehyde in the polyester resin of the invention is at most 50 ppm, preferably at most 30 ppm, more preferably at most 10 ppm. In particular, when the polyester resin of the invention is used as a material for containers for low-flavor drinks such as mineral water, then it is desirable that the aldehyde content of the polyester resin is at most 8 ppm, preferably at most 6 ppm, more preferably at most 5 ppm. If the aldehyde content is larger than 50 ppm, then the content flavor retentiveness of the shaped articles formed from the polyester resin of the type becomes poor. From the viewpoint of the resin production, the lower limit of the aldehyde content is preferably 0.1 ppb. The “aldehydes” as referred to herein mean acetaldehyde when the polyester resin is one comprising ethylene terephthalate as a main constitutive unit thereof, and allylaldehyde when the polyester resin is one comprising 1,3-propylene terephthalate as a main constitutive unit thereof.

It is desirable that the cyclic ester oligomer content in the polyester resin of the invention is at most 70%, preferably at most 60%, more preferably at most 50%, even more preferably at most 35% with respect to the cyclic ester oligomer content of the melt polycondensate for the polyester resin.

The content of cyclic trimers in the polyester resin of the invention, especially in the polyester resin that comprises ethylene terephthalate as a main repetitive unit thereof is at most 0.7% by weight, preferably at most 0.5% by weight, more preferably at most 0.40% by weight. When a heat-resistant blow-molded article is formed from the polyester resin of the invention, then the resin is heated in a hot mold. When the content of cyclic trimers in the resin is larger than 0.7% by weight, then the oligomer adhesion to the surface of the hot mold significantly increases and therefore the transparency of the obtained blow-molded article is greatly deteriorated.

Regarding the shape thereof, the polyester resin chips of the invention may be cylindrical, cubic, spherical or tabular, and the mean particle size thereof may be generally from 1.0 to 5 mm, preferably from 1.1 to 4.5 mm, more preferably from 1.2 to 4.0 mm. For example, the cylindrical chips for practical use have a length of about from 1.0 to 4 mm and a diameter of about from 1.0 to 4 mm. The spherical particles for practical use are such that the maximum particle size thereof is from 1.1 to 2.0 times the mean particle size thereof and the minimum particle size thereof is at least 0.7 times the mean particle size thereof. The weight of the chips for practical use is from 2 to 40 mg/chip.

It is desirable that, when the polyester resin of the invention is melted at a temperature of 290° C. for 60 minutes, then the increment of the cyclic ester oligomer in the resin is at most 0.50% by weight, more preferably at most 0.30% by weight, even more preferably at most 0.10% by weight. If the increment of the cyclic ester oligomer in the resin melted at a temperature of 290° C. for 60 minutes is larger than 0.50% by weight, then the amount of the cyclic ester oligomer in the resin increases when the resin is melted to be shaped, and therefore the oligomer adhesion to the hot mold used significantly increases and the transparency of the obtained blow-molded article is greatly deteriorated.

The polyester resin of the invention, in which the increment in the cyclic ester oligomer is at most 0.50% by weight when the resin is melted at a temperature of 290° C. for 60 minutes, can be produced by inactivating the polycondensation catalyst in the polyester resin obtained after the melt polycondensation or solid-phase polymerization. For inactivating the polycondensation catalyst in the polyester resin, herein employable is a method of contacting the polyester resin chips with water, water vapor or water vapor-containing gas after the melt polycondensation or the solid-phase polymerization.

The method of contacting the polyester resin chips with water, water vapor or water vapor-containing gas is described below. In the invention, the treatment of polyester resin chips with water, water vapor or the like is referred to as water treatment.

For the water treatment, employable is a method of dipping the chips in water or a method of sousing water over the chips with a shower. The treatment time may be from 5 minutes to 2 days, preferably from 10 minutes to one day, more preferably from 30 minutes to 10 hours. The temperature of water or water vapor may be from 20 to 180° C., preferably from 40 to 150° C., more preferably from 50 to 120° C.

An example of a method of industrially carrying out the water treatment is described below, but the invention should not be construed as being limited thereto. The treatment method may be carried out either in a continuous mode or in a batchwise mode, but continuous treatment is preferred for carrying out the treatment industrially.

When the polyester resin chips are subjected water treatment in a batchwise mode, then a silo-type processing tank may be used. Specifically, the polyester resin chips are batchwise put into a silo in which they are subjected to water treatment. When the polyester resin chips are subjected to water treatment in a continuous mode, then they are continuously or intermittently put into a tower-type processing tank from the top of the tank and are subjected to water treatment therein.

In industrial-scale water treatment of the polyester resin chips, a large amount of water is needed for the treatment, for which, therefore, natural water (industrial water) or waste water is often used through recycling. In general, such natural water represents one collected from river water or ground water and pretreated for sterilization or removal of foreign substances without changing the form of water (liquid). In general, natural water for industrial use contains many nature-derived inorganic particles such as typically clay minerals, e.g., silicates, aluminosilicates, as well as bacteria and bacteria, and organic particles originating from rotten plants or animals. When the water treatment is carried out by the use of such natural water, then the particles adheres to the polyester resin chips and penetrates thereinto to form crystal nuclei, and the transparency of blow-molded articles formed from such polyester resin chips becomes extremely poor.

Accordingly, it is desirable that the water treatment, either in the continuous mode or the batchwise mode, satisfies at least one of the following relationships (5) to (9) in which X indicates the number of particles having a particle size of from 1 to 25 μm and existing in the external water introduced into the system, N indicates the sodium content of the water, M indicates the magnesium content thereof, C indicates the calcium content thereof, S indicates the silicon content thereof.
1≦X≦50000 (particles/10 ml) (5)
0.001≦N≦1.0 (ppm) (6)
0.001≦M≦0.5 (ppm) (7)
0.001≦C≦0.5 (ppm) (8)
0.01≦S≦2.0 (ppm) (9)

When any of the number of the particles in the water to be introduced into the water treatment chamber, and the sodium, magnesium, calcium or silicon content in the water is defined to fall within the range as described above, then metal-containing substances such as oxides and hydroxides that are referred to as scale may be prevented from floating or precipitating in the treatment water or from adhering to the processing tank wall or to the piping wall, and they may be prevented from adhering to or penetrating into the polyester resin chips to promote crystallization during shaping, and as a result, the resulting bottles are prevented from having poor transparency.

For the method of reducing the number of the particles in the water to be introduced into the water treatment tank to at most 50000 particles/10 ml, a device capable of removing particles is disposed in at least one site or more in the process up to the stage where natural water such as industrial water is fed to the processing tank. Examples of the device include the same device as that used for treating the chips-cooling water as described above.

For reducing sodium, magnesium, calcium and silicon in the water to be introduced into the water treatment tank, a device capable of removing sodium, magnesium, calcium and silicon is disposed in at least one site or more in the process up to the stage where natural water such as industrial water is fed to the processing tank. Examples of the device include the same device as that used for treating the chips-cooling water as described above.

In the continuous water treatment system in the invention, it is desirable that the dissolved oxygen concentration in the treatment water to be introduced into the system from the outside and/or in the treatment water in the processing tank is controlled to be at most about 18 cm³/liter; and in the batchwise water treatment system, it is also desirable that the dissolved oxygen concentration in the treatment water to be filled in the system from the outside and/or in the treatment water in the processing tank is controlled to be at most about 18 cm³/liter.

At the same time, when the dissolved oxygen concentration in the treatment water in the processing tank is represented by Y cm³/liter and the temperature of the treatment water is represented by X° C., they satisfies the following relationship: Y≦23.0-0.5.5×10⁻² X, more preferably Y≦22.5-0.5.5×10⁻² X, even more preferably Y≦22.0-0.5.5×10⁻² X, most preferably Y≦21.5-0.5.5×10⁻² X.

The oxygen solubility in ordinary water is about 17.6 cm³/liter under 1 atmosphere and at 80° C., and about 17.2 cm³/liter at 90° C. However, when water is heated, oxygen does not completely go out but dissolves therein to a degree over the solubility thereof causing supersaturation, or oxygen more than the range dissolves in water at the bottom of the processing tank owing to the pressure by the self weight of water. When the polyester resin chips are left for a long period of time after polycondensation and are thereafter subjected to water treatment, then oxygen absorbed by the chips is released into the treatment water to cause a supersaturattion state. In particular, when the chips are subjected to water treatment at such a high temperature over 80° C., it is considered that oxidation reaction of the impurities such as monomers, oligomers, etc. dissolved in the water treatment tank proceeds owing to the influence of the temperature and the supersaturated oxygen and, as a result, the residual foreign taste and the foreign odor increase. In addition, it is considered that oxygen penetrates into the resin chips and this make easier for the chips to emit fluorescence.

External water that is introduced into the system may be directly introduced into the water treatment tank; or it may be mixed with recycled water in the recycled water storage tank or in the recycled water-feeding piping, and then introduced into the water treatment tank.

In either of continuous water treatment or batchwise water treatment, when all or almost all of the treatment water from the processing tank is discharged as industrial waste water, then not only a large amount of fresh water is needed but also there is a concern that the increase in the waste water gives an influence on the environment. Accordingly, when at least a part of the treatment water discharged out of the processing tank is recycled by bringing back into the water treatment tank, then the necessary amount of water can be reduced and the influence of the increase in the waste water on the environment can be reduced. In addition, when the waste water brought back to the water treatment tank still keep the temperature to some extent, then the quantity of heat for heating the treatment water can be reduced.

However, the treatment water discharged out of the processing tank contains fines and filmy substances that had adhered to the polyester resin chips at the stage of receiving the polyester resin chips into the processing tank, but not removed from the chips in the foregoing water treatment, as well as fines and filmy substances of the polyester resin that are formed owing to the friction of the chips together or the friction of the chips against the wall of the processing tank during the water treatment.

Accordingly, when the treatment water discharged out of the processing tank is brought back again into the processing tank and reused therein, then the content of the fines and the filmy substances in the treatment water in the processing tank gradually increases. As a result, the fines and the filmy substances contained in the treatment water may adhere to the wall of the processing tank or the piping wall and may clog the piping.

In addition, the fines and the filmy substances contained in the treatment water again adhere to the polyester resin chips and, in the subsequence step where water is removed by drying, the fines and the filmy substances adhere to the polyester resin chips owing to the electrostatic effect. Therefore, even when the removal of the fines and the filmy substances is carried out after the drying, the removal is hardly attained. Since the fines and the filmy substances have a crystallization-promoting effect, crystallization of the polyester resin is promoted thereby, resulting in providing bottles with poor transparency. Alternatively, the degree of crystallization at the time of crystallizing the mouth part of bottles is made excessively high, so that the dimension of the mouth part falls outside the standardized value range, therefore causing mouth capping failure.

Accordingly, in the invention, when used water is discharged out of a water treatment tank and when at least a part of it is brought back again into the tank and reused therein, then it is desirable that the number of the particles existing in the recycled water and having a particle size of from 1 to 40 μm is controlled to at most 100000 particles/10 ml, preferably at most 80000 particles/10 ml, more preferably at most 50000 particles/10 ml. Herein, the used water that is brought back and reused in the processing tank is referred to as recycled water.

One example of the method for controlling the number of the particles having a particle size of from 1 to 40 μm and existing in the recycled water to at most 100000 particles/10 ml is described below, but the invention should not be construed as being limited thereto. For reducing the number of the particles having a particle size of from 1 to 40 μm and existing in the recycled water to at most 100000 particles/10 ml, a device for removing particles is disposed in at least one or more sites in the process from discharging the used water out of the processing tank to again recirculating it into the tank. The device for removing particles includes a filter device, a membrane filtration device, a flocculation tank, a centrifugal device, a bubbles-associated processor. For example, the filter device includes an automatic self-cleaning system, a belt filter system, a bag filter system, a cartridge filter system, a centrifugal filter system. Of those, a belt filter system, a centrifugal filter system and a bag filter system are preferred for continuous filtration process. In the belt filter system, the filter may be formed of paper, metal or cloth. For making better the removal of particles and the flow of treatment water, the filter pore size may be from 5 to 100 μm, preferably from 5 to 70 μm, more preferably from 5 to 40 μm.

In the case of contacting the polyester resin chips with water vapor or water vapor-containing gas, water vapor or water vapor-containing gas at a temperature of from 50 to 150° C., preferably from 50 to 110° C. is supplied or is made present in an amount, preferably, of 0.5 g in terms of water vapor, whereby the two are contacted with each other.

Preferably, the oxygen concentration in the gas is at most 50 ppm, more preferably at most 10 ppm, even more preferably at most 5 ppm.

The contacting of the polyester resin chips with water vapor is carried out generally for from 10 minutes to 2 days, preferably from 20 minutes to 10 hours.

An example of an industrial method of contacting the granular polyester resin with water vapor or water vapor-containing gas is described below, but the invention should not be construed as being limited thereto. The method may be either of a continuous mode or a batchwise mode.

When the polyester resin chips are batchwise contacted with water vapor, employable is a silo-type processor. Specifically, the polyester resin chips are put into a silo, in which they are contacted with water vapor or water vapor-containing gas fed thereinto in a batchwise mode.

When the polyester resin chips are continuously contacted with water vapor, then granular polyethylene terephthalate is continuously put into a tower-type processor from the top thereof while water vapor is also continuously led thereinto in a parallel flow or in a countercurrent flow to thereby make the polyester contacted with the water vapor therein.

In the case where the granular polyester resin is processed with water or water vapor as in the above, the resin is then dewatered, for example, with a dewatering device such as a shaking sieve or Shimon Carter, and then optionally fed to the next drying step.

For drying the polyester resin chips that have been contacted with water or water vapor, any ordinary drying treatment for polyester resin may be employed. For continuously drying, generally employed is a hopper-type aeration drier in which the polyester resin chips are fed from its top and drying gas is introduced from its bottom.

In a batchwise drier, the resin chips are dried while a dried inert gas is introduced thereinto under atmospheric pressure.

The drying temperature is from about 50° C. to about 150° C., preferably from about 60° C. to about 140OC; and the drying time is from 3 hours to 15 hours, preferably from 4 hours to 10 hours.

As the drying gas, preferred is an inert gas having a dew point of not higher than −25° C., and having an oxygen concentration of at most 100 ppm, preferably at most 80 ppm, more preferably at most 50 ppm, even more preferably at most 30 ppm, most preferably at most 10 ppm.

The inert gas to be used in the above includes nitrogen gas, carbon dioxide gas and helium gas; but nitrogen gas is most preferred.

However, since the use of an inert gas causes an economical problem, the drying can be carried out with dried air having a dew point not higher than −25° C., and having an SOx content of at most about 0.01 ppm and an NOx content of at most about 0.01 ppm at a temperature of from about 50° C. to about 100° C. for a period of time of from about 3 hours to about 10 hours.

Preferably, the drying device is so designed that the resin introduced thereinto is discharged successively. When the mean residence time of the resin in the device is represented by t, then it is desirable that 95% by weight, preferably 98% by weight, more preferably 99% by weight of the resin is discharged out of the device within a period of time of from 0.9 t to 1.1 t. As the device of such type, preferred are a vertical hopper-type drier which is so designed that the apex angle of the inversed-cone part at the bottom thereof at which an outlet mouth for discharging the dried chips therethrough is disposed is appropriately defined depending on the angle of repose of the chips and a baffle cone is disposed therein, and a horizontal drier with a transportation paddle or a disc disposed at the rotary shaft thereof.

If the dried resin could not be smoothly and successively discharged out of the device or if the device has a dead space, then the chips having stayed in the device for a long period of time suffer from a greater thermal hysteresis, and when those chips are mixed in, then fluorescence intensity (B₀) of the resin product may be over 20 and the fluorescence intensity increment (Bₕ-B₀) after the heat treatment may be over 30 and there is a considerably high possibility that this may cause problems.

When the polyester resin is separated from water and when the polyester resin is thereafter contacted with gas, the gas used is preferably an inert gas or dried air having the same oxygen concentration as that of the gas used in drying the polyester resin.

If various drying conditions do not fall within the above ranges, then the fluorescence intensity (B₀) of the polyester resin may be over 20 and the fluorescence intensity increment (Bₕ-B₀) upon the heat treatment may be over 30 and there is a considerably high possibility that this may cause problems.

It is also important that the drying device is free from dead space where shape-deficient products of chips and fines may stay for a long period of time. If the device has a dead space, then the chips and the like having stayed therein for a long period of time may have a fluorescence intensity (B₀) of higher than 20 and the fluorescence intensity increment (Bₕ-B₀) upon the heat treatment may be over 30 and this causes a problem.

Another method for inactivating the polycondensation catalyst comprises adding a phosphorus compound to the polyester melt after the melt polycondensation or solid-phase polymerization thereof, and mixing them so as to inactivate the polycondensation catalyst.

In the case of the melt polycondensate polyester, there may be employed a method of inactivating the polycondensation catalyst by mixing the polyester resin after the melt polycondensation reaction with a polyester resin containing a phosphorus compound added thereto, in a device capable of mixing them in melt state such as line mixer or the like.

For adding a phosphorus compound to the solid-phase polymerizate polyester resin, herein employable is a method of dry-blending the solid-phase polymerizate polyester resin with a phosphorus compound; or a method of mixing polyester master batch chips having melt-kneaded with a phosphorus compound, and solid-phase polymerizate polyester resin chips. According to these method, a predetermined amount of a phosphorus compound may be added to the polyester resin, and mixed in an extruder or a molding machine whereby the polycondensation catalyst may be inactivated.

The phosphorus compound to be used includes phosphoric acid, phosphorous acid, phosphonic acid and their derivatives. Specifically, various phosphorus compounds used in the above-mentioned melt polycondensation step are usable herein.

In general, polyester resin contains a relatively large amount of fines which are produced during the process of producing the resin and which are the same as the polyester resin chips in the comonomer component and the comonomer content. The fines have the property of promoting the crystallization of the polyester resin and, when the resin contains a large amount of such fines, then there cause problems such that the transparency of the shaped article formed from the polyester resin composition containing the fines is extremely poor and, in the case of bottles, the degree of shrinkage at the time of crystallization of the bottle mouth cannot fall within a defined range and the bottles cannot be airtightly capped. Accordingly, it is desirable that the amount of the fines in the polyester resin of the invention, in which the fines have the same composition as that of the polyester, is from 0.1 to 10000 ppm, preferably from 0.5 to 1000 ppm, more preferably from 1 to 500 ppm, even more preferably from 1 to 300 ppm, most preferably from 1 to 100 ppm. If the content of the fines is smaller than 0.1 ppm, the crystallization rate of the resin will be too low and, for example, the crystallization of the mouth part of blow-molded articles formed from the resin is insufficient. Therefore, the degree of shrinkage of the mouth part cannot fall within a defined range therefore causing capping failure, or the blow-molding and thermal-fixing mold used in forming heat-resistant blow-molded containers is significantly contaminated and the mold must be frequently cleaned in order to obtain transparent blow-molded containers. On the other hand, if the content is larger than 10000 ppm, then the crystallization rate becomes high and, in addition, the fluctuation thereof becomes large. Accordingly, when sheets are formed, their transparency and surface condition becomes poor and, when they are stretched, then their thickness becomes significantly uneven. In addition, the degree of crystallization of the mouth part of blow-molded articles becomes too large and its fluctuation is also great. Therefore, the degree of shrinkage of the mouth part cannot fall within a defined range, causing capping failure and content leakage. Alternatively, the preform for blow-molding is whitened and therefore normal stretching of the preform becomes impossible. In particular, the content of the fines in the polyester resin composition for blow-molded articles is preferably from 0.1 to 500 ppm.

Some such fines and filmy substances may contain those having a melting point higher by from about 10 to 20° C. than the normal melting point thereof. When a feeding device in which impact force or shear force is applied to the melt polycondensate polyester chips or the solid-phase polymerizate polyester chips is used, or when a stirrer in which shear force is applied to the chips is used, then there are formed a large quantity of fines and filmy substances having a melting point higher by about 10 to 20° C. than the normal melting point thereof. The reason is presumed such that since the chips generate heat owing to the great force such as the impact force applied to the surface of the chips, and simultaneously therewith, orientation crystallization of the polyester takes place at the surface of the chips, a compact crystal structure will be formed at the chip-surface. When the polyester resin that contains such higher-melting-point fines is subjected to solid-phase polymerization, or when it is subjected to contact treatment with water as mentioned below, then the melting point of the fines may be further increased. When the polyester resin of the invention is PET, then fines or filmy substances having a melting point of higher than 260° C. to 265° C. may be problematic.

In the invention, the melting point of the chips and the fines is measured by the use of a differential scanning calorimeter (DSC) according to the method mentioned below. The melting peak temperature in DSC is referred to as a melting point. The melting peak indicating the melting point comprises one or plural melting peaks. In the invention, when the melting peak is one, then the peak temperature is the melting point of the resin analyzed. When there appear plural melting peaks, then the highest melting peak temperature of the plural peaks is referred to as “the highest peak temperature of the melting peak temperatures of fines”, and in the following Examples, it is referred to as “melting point of fines”.

The fines and the filmy substances having the property as described above has an effect of further promoting the crystallization of the polyester resin, and when a large quantity of such fines and filmy substances are in the polyester resin, then the transparency of the shaped article formed from the resin may become extremely poor and, as the case may be, the fines and the filmy substances may be a cause of crystallized and whitened foreign substance defects.

However, in order to obtain preforms for blow-molding or sheets, having excellent transparency and excellent blowability, from the polyester resin or the polyester resin composition that contains the above-mentioned higher-melting-point fines and the like, the resin, for example, PET must be melt-molded at a high temperature of 300° C. or higher. However, at such a high temperature of 300° C. or higher, the polyester is thermally decomposed significantly therefore giving a large quantity of by-products such as aldehydes, e.g., acetaldehyde, leading to a serious influence on the flavor of the contents of the shaped articles of the resin. When the polyester composition of the invention contains at least one resin selected from the group consisting of polyolefin resin, polyamide resin and polyacetal resin as mentioned below, then such an additional resin is thermally decomposed in high-temperature molding at 300° C. or higher and gives a large quantity of by-products since the heat stability of the additional resin is generally lower than that of the polyester resin of the invention. A further serious influence is given on the flavor of the contents of the shaped articles formed from the resin composition.

A concrete example of a method for preventing the polyester resin of the invention from containing such fines is described below. In the case of melt polycondensate polyester, the melt polycondensate polyester after melt polycondensation is extruded out through a die into water and cut into chips; or it is extruded out into air and then, while immediately cooled in cold water, cut into chips. Next, the resulting polyester chips are dewatered, and in the subsequent shaking sieving step, or aerating classification step with a gas flow, or water-washing step, the chips not falling within a predetermined size range as well as the fines and the filmy substances are removed, and then, the thus-processed chips are transferred to a storage tank according to a plug transportation system or a bucket-type conveyor transportation system.

The chips are discharged out of the tank with a screw-type feeder, and are transported to the subsequent step according to a plug transportation system or a bucket-type conveyor transportation system, and immediately before or after the contact treatment step mentioned above, these are subjected to aeration classification with an air flow applied thereto to thereby remove the fines from them.

Next, the melt polycondensate polyester from which the fines and the filmy substances have been removed is again subjected to aeration classification with an air flow applied thereto just before the solid-phase polymerization step to thereby further remove the fines and the filmy substances therefrom, and then this is fed to the solid-phase polymerization step. When the prepolymer chips prepared through melt polycondensation are transported to the solid-phase polymerization apparatus, or when the solid-phase-polymerized polyester chips are transferred to the sieving step, the contact treatment step or the storage tank, employed is an apparatus capable of reducing the impact between the chips and the process devices or the transportation pipes as much as possible with some measure, for example, such that a plug transportation system or a bucket-type conveyor transportation system is employed in most of the transportation process, and that a screw feeder is used for taking out the chips from the crystallization device or the solid-phase polymerization reactor. Also in such transportation pipes and during the treatment for removal of fines and films, it is desirable to use an inert gas having an oxygen concentration of at most 100 ppm, preferably at most 80 ppm, more preferably at most 50 ppm, even more preferably at most 30 ppm, most preferably at most 10 ppm.

Polyester resin that contains fluorescence-emitting chips generally contains fines that emit fluorescence to the same degree. The crystallization-promoting effect of the fines that emitted such fluorescence is extremely great, therefore causing various problems in the same degree as described above or in a higher degree than the above. Hence, it is important to reduce the content of such fines as much as possible.

The polyester of the invention, especially the polyester resin comprising ethylene terephthalate as a main repetitive unit thereof is preferably such that the haze of a plate produced by injection-molding of the resin and having a thickness of 5 mm is at most 30% and the crystallization temperature (hereinafter referred to as “Tc1”) with temperature rising of a test piece from a shaped article produced by injection-molding of the resin and having a thickness of 2 mm is within a range of from 150 to 175° C. The haze of the molded plate is more preferably at most 15%, even more preferably at most 10%; and the crystallization temperature (Tc1) with temperature rising is more preferably from 153 to 173° C., even more preferably from 155 to 170° C.

If the haze of the molded plate is larger than-30%, then the transparency of the blow-molded article becomes poor, and in particular, this problem may be serious with the resin articles produced in the mode of stretching blow-molding. On the other hand, if Tc1 is higher than 175° C., then the thermal crystallization rate of the resin becomes extremely low and the crystallization of the mouth part of blow-molded articles is insufficient, thereby causing a problem of content leakage. When Tc1 is lower than 150° C., then it may be problematic in that the transparency of the blow-molded articles becomes poor.

It is desirable that the polyester resin of the invention that comprises ethylene terephthalate as a main repetitive unit thereof has a dimensional change, as determined through thermal mechanical analysis (TMA) of a molded plate produced by injection-molding the resin and having a thickness of 3 mm, of from 1.0% to 7.0%, preferably from 1.2% to 6.0%, more preferably from 1.3% to 5.0%.

If the dimensional change is smaller than 1.0%, then the transparency of the heat-resistant blow-molded containers becomes lower and, this is especially problematic in large-size blow-molded containers of 1.5 liters or more. In addition, it causes other problems that, for producing the polyester resin having a dimensional change of smaller than 1.0%, the equipment cost is increased and the productivity becomes extremely worse. On the other hand, if the dimensional change is larger than 7.0%, then the thermal crystallization rate is low and therefore the degree of shrinkage during heat treatment of the mouth part of heat-resistant blow-molded articles becomes large. This causes a problem of content leakage or another problem that the productivity of blow-molded containers becomes worse. Further, in vacuum forming of sheets, the degree of shrinkage of the formed sheets is large, therefore causing a problem that the cap-opening capability and the fitting property with the cap become poor.

The dimensional change of a shaped article, which is for specifically identifying the polyester of the invention, is determined by the use of a thermal mechanical analyzer (TMA), Mac Science's Type TMA4000S according to the method mentioned below.

The polyester resin composition of the invention preferably comprises the above-mentioned polyester resin and from 0.1 ppb to 50000 ppm of at least one resin selected from the group consisting of polyolefin resin, polyamide resin and polyacetal resin.

The blend ratio of the above-mentioned resin for use in the invention to the polyester resin composition is from 0.1 ppb to 50000 ppm, preferably from 0.3 ppb to 10000 ppm, more preferably from 0.5 ppb to 1000 ppm, even more preferably from 0.5 ppb to 100 ppb. If the blend ratio is smaller than 0.1 ppb, then the crystallization rate is extremely low and the crystallization of the mouth part of blow-molded articles is insufficient. Therefore, when the cycle time is shortened, then the degree of shrinkage of the mouth part cannot fall within a defined range, thereby causing capping failure. In addition, the blow-molding and thermal-fixing mold used in forming heat-resistant blow-molded articles is significantly contaminated and the mold must be frequently cleaned in order to obtain transparent blow-molded articles. On the other hand, if the blend ratio is larger than 50000 ppm, then the crystallization rate becomes high and the crystallization of the mouth part of blow-molded articles becomes excessive, and the degree of shrinkage of the mouth part cannot fall within a defined range, thereby causing capping failure and content leakage. In addition, the preform for blow-molding is whitened and therefore normal stretching of the preform may become impossible. In the case of sheets, when the blend ratio is larger than 50000 ppm, then the transparency becomes extremely poor and the stretching property becomes also deteriorate, and therefore normal stretching becomes impossible. In such a case, only stretched films with uneven thickness and poor transparency may be obtained.

The polyolefin resin that may be incorporated into the polyester resin composition of the invention includes polyethylene resin, polypropylene resin and α-olefin resin. These resins may be crystalline or amorphous.

The polyethylene resin that may be incorporated into the polyester resin composition of the invention includes, for example, ethylene homopolymer, ethylene copolymer with any of other α-olefins having from 2 to 20 carbon atoms or so, such as propylene, butene-1, 3-methylbutene-1, pentene-1,4-methylpentene-1, hexene-1, octene-1, decene-1, or vinyl compounds such as vinyl acetate, vinyl chloride, acrylic acid, methacrylic acid, acrylate, methacrylate, styrene or unsaturated epoxy compound. Specifically, for example, there are mentioned (branched or linear) ethylene homopolymer such as ultra-low, low, middle or high-density polyethylene; and ethylenic resin such as ethylene-propylene copolymer, ethylene-butene-1 copolymer, ethylene-4-methylpentene-1 copolymer, ethylene-hexane-1 copolymer, ethylene-octene-1 copolymer, ethylene-vinyl acetate copolymer, ethylene-acrylic acid copolymer, ethylene-methacrylic acid copolymer, ethylene-ethyl acrylate copolymer.

The polypropylene resin that may be incorporated into the polyester resin composition of the invention includes, for example, propylene homopolymer; propylene copolymer with any of other a-olefins having from 2 to 20 carbon atoms or so, such as ethylene, butene-1,3-methylbutene-1, pentene-1, 4-methylpentene-1, hexene-1, octene-1, decene-1, or vinyl compounds such as vinyl acetate, vinyl chloride, acrylic acid, methacrylic acid, acrylate, methacrylate, styrene or unsaturated epoxy compound; and propylene copolymer with diene such as hexadiene, octadiene, decadiene, dicyclopentadiene. Specifically, for example, there are mentioned propylene homopolymer (atactic, isotactic, syndiotactic polypropylene), and propylenic resin such as propylene-ethylene copolymer, propylene-ethylene-butene-1 copolymer.

The α-olefin resin that may be incorporated into the polyester resin composition of the invention includes homopolymer of α-olefin having from 2 to 8 carbon atoms or so such as 4-methylpentene-1; and copolymer of such α-olefin with any other α-olefin having from 2 to 20 carbon atoms or so such as ethylene, propylene, butene-1, 3-methylbutene-l, pentene-1, hexene-1, octene-1, decene-1. Specifically, for example, there are mentioned butene-1 homopolymer; 4-methylpentene-1 homopolymer; butene-1-based resin such as butene-l-ethylene copolymer, butene-1-propylene copolymer; and 4-methylpentene-1/C₂₋₁₈ α-olefin copolymer.

The polyamide resin that may be incorporated into the polyester resin of the invention includes, for example, polymer of lactam such as butyrolactam, δ-valerolactam, ε-caprolactam, enatolactam, ω-laurolactam; polymer of aminocarboxylic acid such as 6-aminocaproic acid, 11-aminoundecanoic acid, 12-aminododecanoic acid; polycondensate of diamine units of, for example, aliphatic diamine such as hexamethylenediamine, nonamethylenediamine, decamethylenediamine, dodecamethylenediamine, undecamethylenediamine, 2,2,4- or 2,4,4-trimethylhexamethylenediamine, alicyclic diamine such as 1,3- or 1,4-bis(aminomethyl)cyclohexane, bis(p-aminocyclohexylmethane), or aromatic diamine such as m- or p-xylylenediamine, with dicarboxylic acid units of, for example, aliphatic dicarboxylic acid such as glutaric acid, adipic acid, suberic acid, sebacic acid, alicyclic acid such as cyclohexanedicarboxylic acid, or aromatic dicarboxylic acid such as terephthalic acid, isophthalic acid; and their copolymer. Specifically, for example, there are mentioned nylon-4, nylon-6, nylon-7, nylon-8, nylon-9, nylon-11, nylon-12, nylon-66, nylon-69, nylon-610, nylon-611, nylon-612, nylon-6T, nylon-6I, nylon-MXD6, nylon-6/MXD6, nylon-MXD6/MXDI, nylon-6/66, nylon-6/610, nylon-6/12, nylon-6/6T, nylon-6I/6T. These resins may be crystalline or amorphous.

The polyacetal resin that may be incorporated into the polyester resin composition of the invention includes, for example, polyacetal homopolymer and copolymer. The polyacetal homopolymer is preferably polyacetal having a density, as measured according to the measurement method of ASTM-D792, of from 1.40 to 1.42 g/cm³, and having a melt flow ratio (MFR), as measured according to the measurement method of ASTMD-1238 at 190° C. and under a load of 2160 g, of from 0.5 to 50 g/10 min.

The polyacetal copolymer is preferably one having a density, as measured according to the measurement method of ASTM-D792, of from 1.38 to 1.43 g/cm³, and having a melt flow ratio (MFR), as measured according to the measurement method of ASTMD-1238 at 190° C. and under a load of 2160 g, of from 0.4 to 50 g/10 min. The comonomer component for the copolymer includes ethylene oxide and cyclic ether.

For producing the polyester resin composition of the invention with any of the above-mentioned polyolefin resin added thereto, herein employable are ordinary methods, for example, a method of directly adding resin such as polyolefin resin mentioned above to the polyester resin in such a manner that the amount of the additional resin may fall within the range as described above, followed by melt-kneading, or a method of adding the resin as a master batch followed by melt-kneading; as well as a method of directly adding the additional resin in particulate form to the system of producing the polyester resin, for example, in any stage of during melt polycondensation, immediately after polycondensation, immediately after precrystallization, during solid-phase polymerization or immediately after solid-phase polymerization or in any other stage after the production but before the shaping step, or contacting the polyester resin chips with a member of the additional resin as described above in a fluidized condition of the resin chips to thereby incorporate the additional resin to the polyester resin; or a method of melt-kneading the resins after the contact treatment as described above.

As the method of contacting the polyester resin chips with the additional resin member in a fluidized condition of the resin chips, it is desirable that, in a space where the additional resin member exists, the polyester resin chips are made to colloid against the resin member. Specifically, for example, in the production process for the polyester resin immediately after the melt polycondensation, or immediately after the precrystallization or immediately after the solid-phase polymerization to give the polyester resin, or in the step of transportation of the product of the polyester resin chips, when the resin chips are filled in a transportation container or are taken out of it, or in the step of shaping the polyester resin chips, when the resin chips are put into a shaping machine, a part of the pneumatic power transportation piping, the gravity transportation piping, the silo, or the magnet part such as magnet catcher is formed from the additional resin, or is lined with the additional resin, or a rod-shaped or a net-like member of the additional resin is disposed inside the transfer route, and the polyester resin chips are transferred through the transfer route. The time for contact of the polyester resin chips with the resin member may be generally an extremely short period of time of from 0.01 seconds to a few minutes, within which a minor amount of the additional resin may be incorporated into the polyester resin.

The polyester resin and the polyester resin composition of the invention may be mixed with PET that is produced by the use of a starting material of dimethyl terephthalate or terephthalic acid purified and recovered from used PET bottles according to a chemical recycling method, as a part of the starting material thereof, or mixed with flaky PET or chip-shaped PET purified and recovered from used PET bottles according to a mechanical recycling method.

The polyester resin and the polyester resin composition of the invention are favorably used as blow-molded articles, trays, wrapping materials such as biaxially-stretched films, films for coating metal cans, and fibers including monofilaments. In addition, the polyester resin and the polyester resin composition of the invention are also usable as one constitutive layer of multi-layered shaped articles or multi-layered films.

The polyester resin and the polyester resin composition of the invention may form films, sheets, containers and other wrapping materials according to an ordinary melt forming method. At least monoaxially stretching the sheet formed from the polyester resin or the polyester resin composition of the invention improves the mechanical strength of the sheet. The stretched film of the polyester resin or the polyester resin composition of the invention may be formed by stretching a sheet that is produced through injection molding or extrusion molding, according to any stretching method of monoaxial stretching, subsequent biaxial stretching or simultaneous biaxial stretching generally employed for stretching PET. The polyester resin and the polyester resin composition of the invention may be formed into cups or trays according to a pressure forming or vacuum forming method.

Before shaped, the polyester resin and the polyester resin composition of the invention are generally dried. The drying temperature may be from about 50° C. to about 150° C., preferably from about 60° C. to about 140OC; and the drying time may be from about 1 hour to about 20 hours, preferably from about 2 hours to 10 hours.

As the drying gas, preferred is an inert gas having a dew point not higher than −25° C. and having an oxygen concentration of at most 100 ppm, preferably at most 10 ppm, more preferably at most 5 ppm, most preferably at most 1 ppm, and preferably, the fluctuation width is within 30%, more preferably within 20%.

The inert gas to be used in the above may be nitrogen gas, carbon dioxide gas or helium gas; but nitrogen gas is most preferred.

However, since the use of an inert gas an economical problem, the drying may be carried out with dried air having a dew point not higher than −25° C., and having an SOx content of at most about 0.01 ppm and an NOx content of at most about 0.01 ppm at a temperature of from about 50° C. to about 100° C. for a period of time of from about 3 hours to about 10 hours.

It is important that the drying device is free from dead space where shape-deficient products of chips and fines may stay for a long period of time. If the device has a dead space, then the fluorescence intensity (B₀) of the chips and others staying therein for a long period of time may be over 20 and the fluorescence intensity increment (Bₕ-B₀) upon the heat treatment may be over 30 and there is a considerably high possibility that this may cause problems.

Means for attaining the invention are described hereinabove, but it is not always necessary that all the steps and the conditions must be satisfied. When the fluorescence from a resin is strong, then some suitable measures of employing severer conditions of the above may be taken to obtain the polyester that falls within the range of the invention, and this may be used.

Regarding various applications in the case of PET, specific production methods are briefly described below.

In producing stretched films, the stretching temperature is generally from 80 to 130° C. The stretching may be effected monoaxially or biaxially, but is preferably biaxially in view of the physical properties of practicable films. The draw ratio in monoaxial stretching may be generally from 1.1 to 10 times, preferably from 1.5 to 8 times; and that in biaxial stretching may be generally from 1.1 to 8 times, preferably from 1.5 to 5 times both in the machine direction and in the cross direction. The ratio of machine direction draw ratio/cross direction draw ratio is generally from 0.5 to 2, preferably from 0.7 to 1.3. The resulting stretched film may be further thermally fixed to thereby improve the heat resistance and the mechanical strength of the film. The thermal fixation is effected generally under tension, at 120 to 240° C., preferably at 150 to 230° C., generally for a few seconds to a few hours, preferably for tens seconds to a few minutes.

In producing blow-molded articles, a preform formed from the polyester resin or the polyester resin composition of the invention is molded in a mode of stretch-blow molding, for which any ordinary PET blow molding device may be used. Specifically, for example, a preform is once formed in a mode of injection molding or extrusion molding, this is directly worked to form a mouth part and a bottom, then this is re-heated, and further worked according to a biaxial-stretch blow molding method such as a hot parison method or a cold parison method. In this case, the molding temperature, specifically the temperature of each member of the cylinder and the nozzle of the molding machine is generally from 260 to 300° C. The stretching temperature may be generally from 70 to 120° C., preferably from 90 to 110° C.; and the draw ratio may be generally from 1.5 to 3.5 times in the longitudinal direction and from 2 to 5 times in the circumferential direction. The resulting blow-molded article may be used directly as such, but for use for drinks that require hot filling such as fruit juices or oolong tea, in general, it is further subjected to thermal fixation in the blowing mold to thereby impart heat resistance to the article. The thermal fixation is effected generally under tension such as under pressure at 100 to 200° C., preferably at 120 to 180° C., for a few seconds to a few hours, preferably for a few seconds to a few minutes.

In order to impart heat resistance to the mouth part of bottles, the mouth part of the preform obtained through injection molding or extrusion molding is crystallized in an oven equipped with a far-IR or near-IR heater, or after bottles are formed, the mouth part thereof is crystallized by the use of the heater.

If desired, various additives may be added to the polyester resin and the polyester resin composition of the invention. The additives include known UV absorbent, antioxidant, oxygen scavenger, lubricant as external additive, lubricant internally deposited during reaction, mold release agent, nucleating agent, stabilizer, antistatic agent, dye, pigment.

When the polyester resin and the polyester resin composition of the invention are used for films, then they may contain various inert particles, for example, inorganic particles such as calcium carbonate, magnesium carbonate, barium carbonate, calcium sulfate, barium sulfate, lithium phosphate, calcium phosphate, magnesium phosphate; organic salt particles such as calcium oxalate, terephthalate with calcium, barium, zinc, manganese or magnesium; crosslinked polymer particles of homopolymer or copolymer of vinyl monomer such as divinylbenzene, styrene, acrylic acid, methacrylic acid, acrylic acid or methacrylic acid, for improving the handlability such as the slidability, the windability, and the blocking resistance of the films.

### EXAMPLES

The invention is described more specifically with reference to the following Examples, to which, however, the invention should not be limited.

Methods for measuring principal characteristic values are described below.

(1) Intrinsic Viscosity (IV) of Polyester:

Obtained from the solution viscosity in a mixed solvent of 1,1,2,2-tetrachloroethane/phenol (⅔ by weight) at 30° C.

(2) Diethylene Glycol Content (Hereinafter Referred to as “DEG Content”) of Polyester:

A polyester is decomposed with methanol, the DEG amount is determined through gas chromatography, and the DEG content of the polyester is represented as the ratio (mol %) to the whole glycol component.

(3) Cyclic trimer Content (Hereinafter Referred to as “CT Content”) of Polyester:

A sample is frozen and ground, dissolved in a mixture of hexafluoroisopropanol/chloroform, and diluted with chloroform added thereto. Methanol is added thereto whereby the polymer is deposited, and then this is filtered. The resulting filtrate was evaporated to dryness, and dimethylformamide is added thereto to make it have a predetermined volume. This is analyzed through liquid chromatography to quantitatively determine the cyclic trimer that comprises an ethylene terephthalate unit.

(4) Acetaldehyde Content (Hereinafter Referred to as “AA Content”) of Polyester:

A sample/distilled water=1 g/2 cc is put into a nitrogen-purged glass ampoule, and its top is melt-sealed. This is extracted at 160° C. for 2 hours, and cooled, and the acetaldehyde content of the extract is determined through high-sensitivity gas chromatography, and its concentration is expressed as ppm.

(5) Cyclic Trimer Increment (ACT Amount) of Polyester Upon Melt:

3 g of dry polyester chips are put into a test tube of glass, and melted by dipping it an oil bath at 290° C. in a nitrogen atmosphere for 60 minutes. The cyclic trimer increment upon melt is obtained according to the following formula:
Cyclic trimer increment upon melt (% by weight)=(cyclic trimer content (% by weight) after melt)−(cyclic trimer content (% by weight) before melt).
(6) Determination of Color b, Color b Value Increment After Heat treatment:

The color b value of resin chips is determined by the use of a calorimeter (Tokyo Denshoku's Model TC-1500MC-88).

The color b value increment after heat treatment is obtained as the difference between the color b value of the chips that are heat-treated in (12) and the color b value of the non-treated chips. A larger b value means that the chips are yellowed more.

(7) Determination of Content of Fines:

About 0.5 kg of a resin is put on a two-stage sieve unit that comprises a metal gauze sieve (A) having a nominal dimension according to JIS-Z8801 of 5.6 mm and a metal gauze sieve (B) having a nominal dimension of 1.7 mm (diameter 20 cm), and this is sieved therethrough with shaking at 1800 rpm for 1 minute by the use of a sieve shaker, Teraoka's SNF-7. This operation is repeated, and 20 kg in total of the resin is sieved. However, when the content of fines is small, then the amount of the sample is suitably changed.

The fines having passed through the sieve (B) are washed with an aqueous solution of 0.1% cationic surfactant, then washed with ion-exchanged water, and collected through filtration with a GI glass filter by Iwaki Glass. Along with the glass filter, this is dried in a drier at 100° C. for 2 hours, then cooled and weighed. Again, the same operation of washing it with ion-exchanged water and drying it is repeated, and after it is confirmed that the sample has come to have a constant weight, the weight of the glass filter is subtracted from the weight of the sample. This indicates the weight of the fines. The content of the fines is (weight of fines)/(weight of all the sieved resin).

(8) Mean Density of Polyester Chips, Density of the Mouth Part of Preform, and the Density Deviation of the Mouth Part:

Measured in a density gradient tube of calcium nitrate/aqueous solution at 30° C.

The density of the mouth part is obtained as a mean value of 10 samples crystallized according to the method of (11), and the density deviation of the mouth part is obtained from the values of these 10 samples.

(9) Determination of Melt Peak Temperature of Fines (Melting Point of Fines):

Measured with a differential scanning calorimeter (DSC), Seiko Electronics Industry's RDC-220. The fines obtained from 20 kg of a polyester according to the method of (7) are frozen and ground, and dried under reduced pressure at 25° C. for 3 days. 4 mg of the sample is used in one measurement test. This is subjected to DSC at a heating rate of 20° C./min, and the highest point of the melting peak temperatures of the sample is read. For the measurement, at most 10 samples are used, and the data of the highest melting peak temperature of all the tested samples are averaged to give an average value. (10) Haze (%), and haze mottle of shaped plate:

Samples are cut out from a shaped plate (plate thickness, 5 mm) of the following (16) and from the body part of a blow-molded article (wall thickness, about 0.45 mm) of the following (17), and analyzed by the use of a haze meter, Nippon Denshoku's Model NDH2000. Shaped plates (thickness, 5 mm) produced in continuous 10 molding shots are analyzed in their haze, and their haze mottle is obtained according to the following formula:
Haze mottle of shaped plate (%)=(maximum value of haze (%))−(minimum value of haze (%)).
(11) Density Increment in the Mouth Part of Preform Under Heat:

The mouth part of a preform is heated with a homemade IR heater for 180 seconds, a sample is collected from its top surface and its density is measured.

(12) Determination of Fluorescence Intensity of Polyester, and Confirmation of Fluorescence Emission Thereof:

i) Method for Measurement of Fluorescence Intensity:

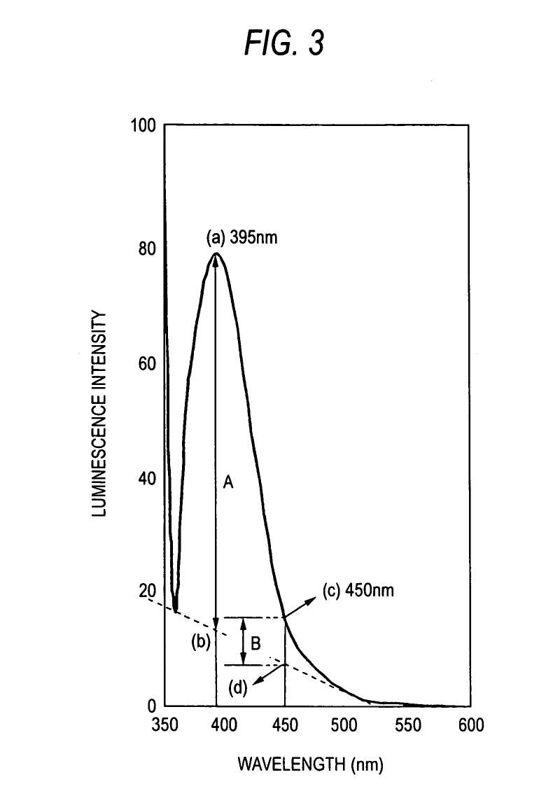

About 5 to 6 g of sample chips collected at random are tightly packed into a solid sample cell (inner diameter 24.5 mm, height 12 mm), covered with a quartz glass plate, and set on a sample holder of a spectrofluorophotometer (Shimadzu's Model RF-540). Excited light is applied to the sample at an angle of 45 degrees, and the fluorescence emitted by the sample is taken out in the right angle direction and introduced into the spectrometer in which the fluorescence spectrum is measured under the condition mentioned below. The ordinate intensity is from 0 to 100. FIG. 3 shows a fluorescence spectrum of PET. Condition for measurement:
Abscissa scale: x2,
Ordinate scale: x4,
Scan speed: fast,
Sensitivity: low,
Excitation slit (nm): 5,
Emission slit (nm): 5,
Excitation wavelength: 343 nm,
Emission start wavelength: 350 nm,
Emission end wavelength: 600 nm.

A tangent line is drawn on the low wavelength side and on the high wavelength side of the emission spectrum of the sample chips obtained according to the above method, and the length A between the point (a) of the spectrum at 395 nm and the intersection point (b) of the vertical line drawn downward from the point (a) to the tangent line, and the length B between the point (c) of the spectrum at 450 nm and the intersection point (d) of the vertical line drawn downward from the point (c) to the tangent line are measured. A and B are represented as relative values to the length 100 indicating the fluorescence intensity of from 0 to 100; and these are the fluorescence intensity (A) at 395 nm and the fluorescence intensity (B) at 450 nm. The chips are exchanged for new ones, and measured 5 times, and the data are averaged to obtain an average value. In actual measurement, the peak at 395 nm and the peak at 450 nm may vary by a few nm. In such a case, the spectral peak value is employed. When a definite peak could not be obtained, then the values at 395 nm and 450 nm are employed.

The fluorescence intensity A and B of non-heated chips is referred to as A₀ and B₀, respectively. ii) Fluorescence intensity of heat-treated polyester:

The fluorescence intensity increment is as follows: The fluorescence spectrum of the polyester chips heated according to the method of (13) is determined in the same manner as described above, and the fluorescence intensity at 395 nm of the heat-treated chips is represented by Aₕ, and that at 450 nm thereof is by Bₕ.

iii) Selection of Fluorescent Chips (for Measurement of B₅₀, Aₛ₀, Bₛₕ, Aₛₕ):

About 500 g of non-heated polyester chips or polyester chips heated according to the method of (13) are exposed to a black light (National FL20S, BL-B, 20 W—this emits near-UV rays of from 300 to 400 nm, and its maximum wavelength is 352 nm), and visually checked, and about 2 to 3 g of the chips of stronger fluorescence emission are selected. These are ground in a freezing grinder (SPEX Freezer Mill), and about 1 g of the ground powder is densely packed into a solid sample cell of quartz (inner diameter 24.5 mm, height 2 mm), covered with a quartz glass cover, and analyzed in the same manner as described above. In the case where all the chips give fluorescence emission of almost the same level when exposed to the black light, then the sample to be analyzed may be randomly selected from the chips.

iv) Fluorescence Characteristics:

The fluorescence emission characteristics in the Examples are obtained according to the following calculation:
Fluorescence intensity=B₀,
Fluorescence intensity ratio=B₀/A₀,
Fluorescence intensity increment after heat treatment=Bₕ−B₀,
Fluorescence intensity ratio after heat treatment=Bₕ/Aₕ,
Fluorescence intensity ratio difference after heat treatment=Bₕ/Aₕ−B₀/A₀,
Fluorescence intensity ratio of selected chips=Bₛ₀/Aₛ₀,
Fluorescence intensity increment in the chips selected after heat treatment=Bₛₕ−Bₛ₀,
Fluorescence intensity ratio after heat treatment of the chips selected after heat treatment=Bₛₕ/Aₛₕ.
v) Confirmation of Fluorescence Emission of Polyester Shaped Article:

A sample is exposed to a black light (National FL20S, BL-B, 20 W—this emits near-UV rays of from 300 to 400 nm, and its maximum wavelength is 352 nm), and visually checked.

(13) Heat Treatment of Polyester:

20 g of a sample dried under reduced pressure of 10 Torr or less at about 80° C. for 8 hours is put into a 100-ml container of glass (mouth inner diameter 41 mm, body outer diameter 55 mm, overall height 95 mm), set on the turntable of a gear-type aging tester, Nagano Kagaku Kikai Seisakusho's NH-202GT, and heated in an air atmosphere at 180° C. for 10 hours.

(14) Crystallization Temperature with Temperature Rising of Shaped Article (Tc1):

Measured with a differential scanning calorimeter (DSC), Seiko Electronics Industry's RDC-220. 10 mg of a sample is taken out from the center part of a 2-mm thick plate of the shaped plate of the following (16), and this is analyzed. This is heated at a heating rate of 20° C./min, and the peak temperature of the crystallization peak observed during the heating is read. This is the crystallization temperature with temperature rising (Tc1) of the sample.

(15) Dimensional Change of Shaped Article:

A sample having a size of 8 mm×10 mm is cut out from the 3-mm thick plate part of the stepped shaped plate of the following (16), and this is analyzed. The shaped plate has molecular orientation derived from the resin flow during molding operation, but the orientation condition differs in different sites of the shaped plate. Accordingly, the shaped plate is sandwiched between two polarizers with the polarizing faces of the two being positioned perpendicularly to each other, and visible light is radiated to it in the direction vertical to the surface of the polarizers. The light intensity distribution passing through the shaped plate is observed whereby the orientation condition of the shaped plate is confirmed. Test pieces are cut out from the sample in the site thereof not containing any uneven molecular orientation (with no fluctuation in the degree of orientation and the orientation direction) within the range of the above dimension. In this stage, the direction of the optical anisotropy of the sample is previously confirmed, and the relationship between the direction of the test pieces to be cut out and the direction of the optical anisotropy of the sample is defined as in the following: Using a polarizing microscope and a sensitive color plate, the direction of the optical anisotropy is determined according to the method described in New Polymer Experimental Technology 6, Polymer Structure (2) (by Kyoritsu Publishing). The test pieces are cut out in such a manner that the axis having a smaller refractive index (the axis for rapider light transmission) of the sample may be in parallel to the major axis of the test pieces. The orientation disturbance introduced thereinto when cutting out the test pieces and the roughness of the cut face of the test pieces have significant influences on the test data. Accordingly, using a cuter, the roughness of the cut face and the orientation-disturbed site are removed from the test pieces, and the surface of the test pieces is flattened.

In addition, the density and the degree of molecular orientation of the test pieces also have some influence on the test data. The density and the birefringence data must be from 1.3345 to 1.3355 g/cm³ and from 1.30×10⁻⁴ to 1.50×10⁻⁴, respectively. The density is measured as follows: A resin piece sampled out from the site around which the test pieces have been sampled is analyzed by the use of a water-type density ingredient tube. The birefringence is measured with a polarizing microscope (Nikon's ECLIPSE E600POL) according to a Berek compensator method. The value of the center part of the test piece is employed as the test value. The dimensional change in heating of the test pieces prepared in the manner as described above is determined by the use of a thermal mechanical analyzer (TMA), Mac Science's Type TMA 4000S. The measurement is carried out as follows: Under a compression load mode, the change in the sample length in the direction parallel to the major axis of the test piece is measured. Under a constant compression load of 0.2 g applied thereto, the sample is heated in an Ar atmosphere from room temperature up to 210° C. at a heating rate of 27° C./min, and kept at 210° C. for 180 seconds, and the cooled to room temperature at a cooling rate of 47° C./min. In the heat cycle, the dimensional change of the sample is determined. The dimensional change is calculated according to the following formula:
Dimensional change (%)=100×[(sample length at room temperature before the heat cycle test)−(sample length at room temperature after the test)]/(sample length at room temperature before the test).
(16) Molding of Stepped Plate:

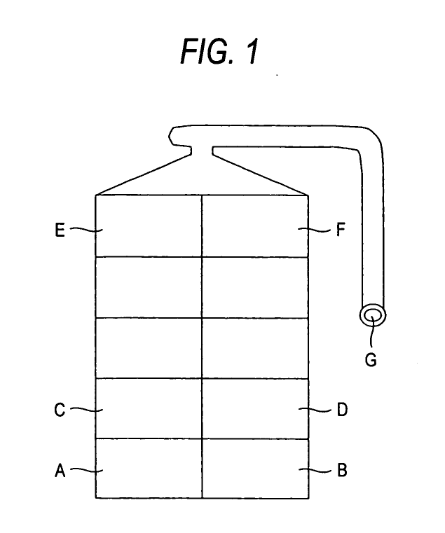

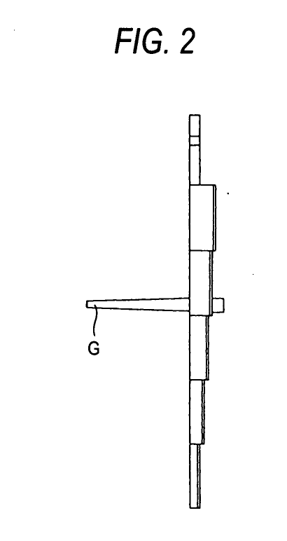

In this description, a stepped plate is molded as follows: Using a reduced pressure drier, polyester chips are dried under reduced pressure at 140° C. for about 16 hours. Using an injection-molding machine, Meiki Seisakusho's Model M-15° C.-DM, the polyester chips are injection-molded into a stepped plate having a thickness of from 2 mm to 11 mm (thickness of part A=2 mm, thickness of part B=3 mm, thickness of part C=4 mm, thickness of part D=5 mm, thickness of part E=10 mm, thickness of part F=11 mm) and having a gate part (G) as in FIG. 1 and FIG. 2.

Using a vacuum drier, Yamato Kagaku's Model DP61, polyester chips are previously dried under reduced pressure. In order to prevent the chips from being wetted during molding, the molding material hopper is purged with a dry inert gas (nitrogen gas). The plasticization condition with the injection-molding machine M-150C-DM is as follows: The feed screw rotation is 70%; the screw rotation is 120 rpm; the back pressure is 0.5 MPa; the cylinder temperature is 45° C. and 250° C. in that order just below the hopper; after that, the temperature is 290° C. including the nozzle. The injection condition is as follows: The injection speed and the dwell speed are 20%; the injection pressure and the dwell condition are so controlled that the weight of the molded article may be 146±0.2 g; and the dwell pressure is kept lower by 0.5 MPa than the injection pressure.

The upper limit of the injection time and the dwell time is 10 seconds and 7 seconds, respectively; the cooling time is 50 seconds; and the overall cycle time is about 75 seconds including the product take-out time.

Cooling water at 10° C. is all the time introduced into the mold for conditioning the mold, and the surface temperature of the mold during stable molding is around 22° C.

After the mold is substituted with resin by introducing a molding material thereinto, the test plates for evaluation of the properties of the molded article are selected at random from the stable molded articles at from 11 to 18 shots after the start of the molding.

The 2-mm thick plate (part A in FIG. 1) is used for measuring the crystallization temperature (Tc1) with temperature rising; the 3-mm thick plate (part B in FIG. 1) is used for measuring the dimensional change; the 5-mm thick plate (part D in FIG. 1) is used for measuring the haze (%).

(17) Production of Blow-Molded Article:

On presumption of excess drying, polyester is dried with a drier using dried air under normal pressure at 140° C. for 10 hours, and, using an injection-molding machine, Meiki Seisakusho's Model M-150C(DM), this is formed into a preform at a resin temperature of 290° C. The mouth part of the preform is thermally crystallized by the use of a homemade mouth crystallization device. Next, using a blow-molding machine, Copoplast's Model LB-01E, the preform is biaxially blown by about 2.5 times in the longitudinal direction and by about 3.8 times in the circumferential direction, and then thermally fixed in a mold set at about 150° C. for about 7 seconds to obtain a container having a capacity of 2000 cc (wall thickness of the body part, 0.45 mm). The blowing temperature is controlled at 100° C.

(18) Evaluation of Content Leak from Blow-Molded Article:

The blow-molded article obtained in the above (17) is filled with hot water at 90° C., and capped with a capping machine. Then, the container is laid down and left as such, and checked for water leakage therefrom. In addition, the capped mouth part is checked for deformation.

(19) Chemical Oxygen Demand (COD) (mg/Liter) of Cooling Water in Chipping Step:

Filtered through a glass filter, Iwaki Glass' 1G1 Filter, cooling water is analyzed according to the method of JIS-K0101.

(20) Sodium Content, Calcium Content, Magnesium Content and Silicon Content in Cooling Water in Chipping Step and in Circulating Water in Water Treatment Step:

After processed for removal of particles and for ion-exchange treatment, cooling water and circulating water are sampled, and then filtered through a glass filter, Iwaki Glass' 1G1 Filter, and the filtrate is analyzed with an inductively coupled plasma-atomic emission spectrometer by Shimadzu.

(21) Determination of the Number of Particles in Cooling Water in Chipping Step, in Circulating Water in Water Treatment Step, and in Recycled Water:

After processed for removal of particles and for ion-exchange treatment, cooling water, circulating water and recycled water treated in the filter device (5) and the adsorption column (8) are analyzed to determine the number of particles existing therein, using a device for counting the number of particles according to a light-blocking method, Seishin Kigyo's Model PAC 150. The number of particles is expressed in terms of particles/10 ml.

(22) Dissolved Oxygen Concentration:

Measured according to the dissolved oxygen determination method described in the item “24. Dissolved Oxygen” in JIS-KO101 for industrial water test method. This is measured in any method of a Winkler method, a Winkler-sodium azide modification method, a Miller modification method or a diaphragm electrode method. External water introduced into the system from the outside is sampled through the take-out mouth disposed near to the ion-exchange water introducing mouth of the cooling water tank or the water treatment tank; and the treating water in the cooling water tank or the water treatment tank is sampled through the water take-out mouth of each tank.

### Example 1-1

From high-purity terephthalic acid and ethylene glycol as starting materials, PET was produced in a continuous melt polycondensation device and a continuous solid-phase polymerization device.

Into a first esterification reactor previously containing a reaction product, a slurry of high-purity terephthalic acid and ethylene glycol prepared in a slurry-preparing chamber was continuously fed, and with stirring, these were reacted at about 250° C. under 0.5 kg/cm²G for a mean residence time of 3 hours.

The reaction product was transferred into a second esterification reactor, and further reacted with stirring at about 260° C. under 0.05 kg/cm²G to a predetermined reaction degree. A polycondensation catalyst, crystalline germanium dioxide (sodium content, 0.7 ppm; potassium content, 0.5 ppm; heat loss, 2.8%) was dissolved in water under heat, and ethylene glycol was added thereto under heat. The resulting solution, and an ethylene glycol solution of phosphoric acid were separately continuously fed into the second esterification reactor. Nitrogen gas having an oxygen concentration of at most 2 ppm was kept introduced into the slurry-preparing chamber and the reactors, whereby the oxygen concentration in the gaseous phase in the slurry-preparing chamber was kept from 20 to 30 ppm or less, and the oxygen concentration in the gaseous phase in the first and second esterification reactors was from 20 to 30 ppm or less. The prepared catalyst solution and phosphoric acid solution were subjected to bubbling with nitrogen gas having an oxygen concentration of at most about 1 ppm, and the same nitrogen gas was kept introduced into the catalyst solution tank and the phosphoric acid solution tank.

The esterification reaction product was continuously fed into a first polycondensation reactor, and with stirring, this was reacted at about 265° C. under 25 Torr for 1 hour, then in a second polycondensation reactor, this was reacted with stirring at about 265° C. under 3 Torr for 1 hour, and further in a final polycondensation reactor, this was reacted with stirring at about 275° C. under 0.5 to 1 Torr for polycondensation. The intrinsic viscosity of the melt polycondensate prepolymer was 0.54 dl/g.

The resulting melt polycondensate prepolymer was extruded out through orifices into cooling water at about 20° C., of which the water quality is shown below, and cut into chips therein. The chips were separated in a mode of liquid-solid separation and centrifuged so that the amount of water adhering to the chips was reduced to at most about 800 ppm. Industrial water (derived from river-bed water) was treated in a flocculation and deposition device, a filtration device, a nitrogen gas-introducing thermal degassing device, an activated charcoal adsorption device, and an ion-exchange device. Thus treated, this contained particles having a particle size of from 1 to 25 μm in an amount of about 500 particles/10 ml, and had a sodium content of 0.06 ppm, a magnesium content of 0.03 ppm, a calcium content of 0.05 ppm, a silicon content of 0.11 ppm, COD of 0.3 mg/liter, a dissolved oxygen concentration of about 28.0 cm³/liter, and this was used as circulating water. The circulating water was introduced into the cooling water storage tank for the chipping step. The waste water from the chipping step was treated in a device for removing fines, in which the filter is a 30-μm thick continuous paper filter, and in an activated charcoal adsorption column for adsorption of ethylene glycol, and almost all of it was returned to the cooling water storage tank and mixed with the fresh circulating water, and this was used as cooling water. The cooling water was continuously circulated and the shortage thereof was made up by supplying the above-mentioned fresh circulating water thereinto, and this was used as cooling water. COD of the cooling water was from 0.3 to 0.5 mg/liter.

Next, the chips were transported into a storage tank in a nitrogen atmosphere in which the oxygen concentration in the gaseous phase was at most 50 ppm, and then fines and filmy substances were removed from them in the subsequent shaking sieving step and pneumatic classification step, whereby the content of the fines in the chips became at most about 50 ppm. This was transported into a crystallization device, and continuously crystallized in a nitrogen gas stream atmosphere having an oxygen concentration of at most 20 ppm at about 155° C. for 3 hours, and then put into a tower-type solid-phase polymerization reactor and subjected to continuous solid-phase polymerization in a nitrogen gas stream atmosphere having an oxygen concentration of from 15 to 20 ppm at about 209° C. to obtain a solid-phase polymerization polyester. A silo-type chamber was used for the precrystallization and the solid-phase polymerization, and the angle at the bottom thereof was made larger by 5 degrees than the angle of repose of the resin, and a baffle cone was disposed in the chamber. After the solid-phase polymerization, the polyester was continuously processed in a sieving step and a step of removing fines whereby the fines and the filmy substances were removed therefrom. The oxygen concentration in the nitrogen gas discharged out from the solid-phase polymerization reactor was at most 25 ppm. In the sealed part of the movable member such as the stirrer and the pump in the melt polycondensation reactor and the solid-phase polymerization reactor, nitrogen gas having an oxygen concentration of at most 2 ppm was kept introduced.

For transporting the melt polycondensate PET chips and the solid-phase polymerizate PET chips, almost used was a bucket-type conveyor transportation system or a plug transportation system; and for taking out from the reactor and the storage tank, mainly used was a screw-type feeder. During the transportation between the steps, the ambient atmosphere was a nitrogen atmosphere having an oxygen concentration of from 30 to 50 ppm; and for the pneumatic classification, used was nitrogen gas having an oxygen concentration of from 30 to 50 ppm.

Thus produced according to the method, PET was evaluated for various properties. The results are shown in Tables 1 and 2.

### Example 1-2

Using a continuous melt polycondensation device and a continuous solid-phase polymerization device that differ from those in Example 1-1, PET was produced.

Into a first esterification reactor previously containing a reaction product, a slurry of high-purity terephthalic acid and ethylene glycol prepared in a slurry-preparing chamber was continuously fed, and with stirring, these were reacted at about 250° C. under 0.5 kg/cm²G for a mean residence time of 3 hours. The reaction product was transferred into a second esterification reactor, and further reacted with stirring at about 260° C. under 0.05 kg/cm²G to a predetermined reaction degree. Crystalline germanium dioxide (sodium content, 0.5 ppm; potassium content, 0.3 ppm; heat loss, 2.7%) was dissolved in water under heat, and ethylene glycol was added thereto under heat. The resulting catalyst solution, and an ethylene glycol solution of phosphoric acid were separately continuously fed into the second esterification reactor. Nitrogen gas having an oxygen concentration of at most 1 ppm was kept introduced into the slurry-preparing chamber and the reactors, whereby the oxygen concentration in the gaseous phase in the slurry-preparing chamber was kept from 20 to 30 ppm or less, and the oxygen concentration in the gaseous phase in the first and second esterification reactors was from 20 to 30 ppm or less. The prepared catalyst solution and phosphoric acid solution were subjected to bubbling with nitrogen gas having an oxygen concentration of at most about 1 ppm, and the same nitrogen gas was kept introduced into the catalyst solution tank and the phosphoric acid solution tank. The esterification reaction product was continuously fed into a first polycondensation reactor, and with stirring, this was reacted at about 265° C. under 25 Torr for 1 hour, then in a second polycondensation reactor, this was reacted with stirring at about 265° C. under 3 Torr for 1 hour, and further in a final polycondensation reactor, this was reacted with stirring at about 275° C. under 0.5 to 1 Torr for polycondensation. The intrinsic viscosity of the melt polycondensate prepolymer was 0.54 dl/g.

The resulting melt polycondensate prepolymer was extruded out through orifices into cooling water at about 20° C., of which the water quality is shown below, and cut into chips therein. The chips were separated in a mode of liquid-solid separation and centrifuged so that the amount of water adhering to the chips was reduced to at most about 900 ppm. Industrial water (derived from river-bed water) was treated in a flocculation and deposition device, a filtration device, a nitrogen gas-introducing thermal degassing device, an activated charcoal adsorption device, and an ion-exchange device. Thus treated, this contained particles having a particle size of from 1 to 25 μm in an amount of about 700 particles/10 ml, and had a sodium content of 0.06 ppm, a magnesium content of 0.03 ppm, a calcium content of 0.02 ppm, a silicon content of 0.11 ppm, COD of 0.3 mg/liter, a dissolved oxygen concentration of about 28.0 cm³/liter, and this was used as circulating water. The circulating water was introduced into the cooling water storage tank for the chipping step. The waste water from the chipping step was treated in a device for removing fines, in which the filter is a 30-μm thick continuous paper filter, and in an activated charcoal adsorption column for adsorption of ethylene glycol, and almost all of it was returned to the cooling water storage tank and mixed with the fresh circulating water, and this was used as cooling water. The cooling water was continuously circulated and the shortage thereof was made up by supplying the above-mentioned fresh circulating water thereinto, and this was used as cooling water. COD of the cooling water was from 0.3 to 0.5 mg/liter.

Next, fines and filmy substances were removed from them in the subsequent shaking sieving step and pneumatic classification step, whereby the content of the fines in the chips became at most about 50 ppm. Before the melt polycondensate prepolymer was fed into the precrystallization device of a continuous solid-phase polymerization system, it was stored in air for about 3 to 5 hours and then immediately transferred into the crystallization device, in which this was continuously crystallized in a nitrogen gas stream atmosphere having an oxygen concentration of at most 20 ppm, and then put into a tower-type solid-phase polymerization reactor and subjected to continuous solid-phase polymerization in a nitrogen gas stream atmosphere having an oxygen concentration of from 15 to 20 ppm at about 208° C. to obtain a solid-phase polymerization polyester. A silo-type chamber was used for the precrystallization and the solid-phase polymerization, and the angle at the bottom thereof was made larger by 5 degrees than the angle of repose of the resin, and a baffle cone was disposed in the chamber. After the solid-phase polymerization, the polyester was continuously processed in a sieving step and a step of removing fines whereby the fines and the filmy substances were removed therefrom. The oxygen concentration in the nitrogen gas discharged out from the solid-phase polymerization reactor was at most 30 ppm.

In the sealed part of the stirrer in the melt polycondensation reactor and the solid-phase polymerization reactor, nitrogen gas having an oxygen concentration of 1 ppm was kept introduced. For transporting the melt polycondensate PET chips and the solid-phase polymerizate PET chips, almost used was a bucket-type conveyor transportation system or a plug transportation system; and for taking out from the reactor and the storage tank, mainly used was a screw-type feeder. During the transportation between the steps, the ambient atmosphere was a nitrogen atmosphere having an oxygen concentration of from 30 to 50 ppm; and for the pneumatic classification, used was nitrogen gas having an oxygen concentration of from 30 to 50 ppm.

Thus produced according to the method, PET was evaluated for various properties. The results are shown in Tables 1 and 2.

### Example 2

A melt polycondensate PET was obtained in the same manner and under the same condition as in Example 1, for which, however, used were an ethylene glycol solution of basic aluminium acetate as a polycondensation catalyst and an ethylene glycol solution prepared by previously heating Irganox 1222 (by Ciba Speciality Chemicals) and ethylene glycol. The intrinsic viscosity of the thus-obtained melt polycondensate PET was 0.58 dl/g. Next, this was subjected to solid-phase polymerization in the same manner as in Example 1.

This was evaluated also in the same manner as in Example 1. The properties of the obtained PET, and those of the molded plate and the biaxially-blown bottle formed therefrom are shown in Table 1 and Table 2. The results were good with no problem.

### Example 3

A melt polycondensate PET was obtained in the same manner as in Example 1, for which, however, used were an ethylene glycol solution of titanium tetrabutoxide, an ethylene glycol solution of magnesium acetate tetrahydrate, and an ethylene glycol solution of phosphoric acid as a polycondensation catalyst. The intrinsic viscosity of the thus-obtained melt polycondensate PET was 0.56 dl/g. Next, this was subjected to solid-phase polymerization in the same manner as in Example 1.

This was evaluated also in the same manner as in Example 1. The properties of the obtained PET, and those of the molded plate and the biaxially-blown bottle formed therefrom are shown in Table 1 and Table 2. The results were good with no problem.

### Example 4

A melt polycondensate PET was obtained in the same manner as in Example 1, for which, however, used were an ethylene glycol solution of antimony trioxide, an ethylene glycol solution of magnesium acetate tetrahydrate, and an ethylene glycol solution of phosphoric acid as a polycondensation catalyst. The intrinsic viscosity of the thus-obtained melt polycondensate PET was 0.59 dl/g. Next, this was subjected to solid-phase polymerization in the same manner as in Example 1.

This was evaluated also in the same manner as in Example 1. The properties of the obtained PET, and those of the molded plate and the biaxially-blown bottle formed therefrom are shown in Table 1 and Table 2. The results were good with no problem.

### Example 5

Used polyethylene terephthalate bottles were selected to remove bottles of different resin from them, and these were delabeled and decapped, and ground and washed with water. The thus-recovered flakes were depolymerized with ethylene glycol in the presence of a depolymerization catalyst, and then interesterified with methanol. The resulting crude dimethyl terephthalate was purified through distillation. Thus obtained, the pure dimethyl terephthalate was hydrolyzed to give high-purity terephthalic acid. Its quality was on the same level as that of high-purity terephthalic acid produced from paraxylene.

A solid-phase polymerization PET was obtained in the same manner as in Example 1, except for using a mixture of 30 parts by weight of the thus-obtained high-purity terephthalic acid and 70 parts by weight of high-purity terephthalic acid obtained from paraxylene.

This was evaluated in the same manner as in Example 1. The properties of the obtained PET, and those of the molded plate and the biaxially-blown bottle formed therefrom are shown in Table 1 and Table 2. The results were good with no problem.

### Example 6

The solid-phase polymerizate PET obtained in Example 1-2 was treated with water in the manner mentioned below.

A tower-type processing tank shown in FIG. 4 was used, which has a capacity of about 50 m³ and which comprises (1) a starting chips-feeing mouth at the top of the tank; (2) an overflow discharge mouth positioned at the upper limit level of treating water in the tank; (3) a take-out mouth for a mixture of polyester chips and treating water at the bottom of the tank; (6) a piping through which the treating water discharged out of the overflow discharge mouth and the treating water discharged out of the discharge mouth at the bottom of the tank and having passed through a dewatering device (4) is sent again to the water treatment chamber via a device (5) for removal of fines which is a continuous filter unit having a 30-μm thick paper filter; (7) an inlet mouth for the treating water from which the fines have been removed; (10) an adsorption tower for adsorbing acetaldehyde and glycol in the fines-removed treating water; (8) an inlet mouth for fresh ion-exchanged water; and (12) a nitrogen gas-introducing degassing device. Using the processing tank, PET chips were treated with water by continuously introducing thereinto ion-exchanged water having passed through a nitrogen gas-introducing thermal degassing device (9) and an activated charcoal treatment device (11).

The solid-phase polymerizate PET chips were processed in a shaking sieving step and a pneumatic classification step so that the content of fines and filmy substances in them was reduced to about 40 ppm, and then these were continuously fed into the processing tank in which the treating water temperature was controlled at 95° C., via the feed mouth (1) at its top, and treated water therein. The water treatment time was 5 hours, and during the water treatment, the PET chips were continuously taken out along with the treating water through the discharge mouth (3) at the bottom of the processing tank. The fresh circulating water sampled just before the ion-exchange water inlet mouth (9) of the processing tank contained particles having a particle size of from 1 to 25 μm in an amount of about 700 particles/ml, and had a sodium content of 0.05 ppm, a magnesium content of 0.03 ppm, a calcium content of 0.03 ppm, a silicon content of 0.12 ppm, a dissolved oxygen concentration of about 17.0 cm³/liter; and the content of particles having a particle size of from 1 to 40 μm in the recycled water from the filtration device (5) and the adsorption tower (8) was about 18000 particles/10 ml.

After thus treated with water, the chips were continuously dried (at 120° C. for 6 hours) with hot dry nitrogen (having an oxygen concentration of at most about 5 ppm) and then treated in a shaking sieving step and a pneumatic classification step in which fines and filmy substances were removed from them and their total content in the chips was reduced to about 50 ppm. The peak temperature on the highest side of the melting peak temperatures of the fines and others was 245° C. For the drying, used was a silo-type container, and the angle at the bottom thereof was made larger by 5 degrees than the angle of repose of the resin, and a baffle cone was disposed.

The obtained PET was evaluated for various properties. The results are shown in Table 1 and Table 2.

In continuous bottle molding according to the method (17), the thermal fixation time in the mold was 2 minutes, and 800 bottles were continuously molded in an accelerated test. As a result, both the 10th shot bottle and the 800th shot bottle were good with no haze.

### Example 7

A cylindrical piping of linear low-density polyethylene (MI=about 0.9 g/10 min, density=about 0.923 g/cm³) having an inner diameter of 70 mm and a length of 700 mm was connected to a part of the transportation piping of SUS304 connected to the transportation container-filling step disposed after the step of removal of fines through pneumatic classification in Example 1-1, and PET chips were transported through the transportation piping at a speed of about 3 tons/hr for contact treatment under a fluidized condition. The ratio A of the cylindrical piping surface area (cm²) to the unit-time treatment amount of polyester (ton/hr) was about 513. After the contact treatment, the chips were further processed in the next pneumatic classification step. The polyethylene content of the chips was about 10 ppb. The obtained PET was evaluated for various properties. The results are shown in Table 1 and Table 2.

### Example 8

After the step of removal of fines in a mode of pneumatic classification after the water treatment in Example 6, the chips were contacted with polyethylene in the same manner as in Example 7. The polyethylene content of the chips was about 12 ppb. The obtained PET was evaluated for various properties. The results are shown in Table 1 and Table 2.

### Comparative Example 1

A prepolymer having an intrinsic viscosity of 0.56 dl/g was obtained through melt polycondensation in the same manner as in Example 1, for which, however, the nitrogen gas bubbling in preparing the polycondensation catalyst and the phosphoric acid solution was stopped, nitrogen gas introduction into the catalyst solution tank was stopped, no nitrogen gas was introduced into the process of from the starting material-preparing tank to the esterification tank (the oxygen concentration in the gaseous phase in these reactors was 1000 ppm or more), no nitrogen gas was introduced into the sealing part of the stirrer of the reactor, and industrial water at about 10 to 15° C. was directly used as the chips-cooling water.

The industrial water used in cooling the chips contained particles having a particle size of from 1 to 25 Am in an amount of from about 60000 to 80000 particles/10 ml, and had a sodium content of from 3.5 to 5.0 ppm, a magnesium content of from 0.7 to 1.0 ppm, a calcium content of from 2.0 to 2.5 ppm, a silicon content of from 3.0 to 4.5 ppm, COD of from 4.0 to 6.7 mg/liter, and a dissolved oxygen amount of from about 42 to 45 cm³/liter; and the amount of the water having adhered to the chips was from about 5000 to 7000 ppm.

The prepolymer was filled in a flexible container and left in air for about 3 hours, and then this was fed into the same continuous solid-phase polymerization device as in Example 1 and subjected to solid-phase polymerization therein. The prepolymer was reacted in the same manner as in Example 1 except that the oxygen concentration in the hot nitrogen fed to the solid-phase polymerization device was 1000 ppm or more.

This was evaluated in the same manner as in Example 1. The properties of the obtained PET, and those of the molded plate and the biaxially-blown bottle formed therefrom are shown in Table 1 and Table 2.

The transparency of the obtained bottles was poor, and grayish brown foreign substances were observed in several places in their body parts. Their mouth parts were checked for deformation and content leakage, and it revealed that the contents were leaked out.

The bottles were exposed to the black light as in the measurement method (12) and visually observed. They emitted serious fluorescence and were therefore problematic.

### INDUSTRIAL APPLICABILITY

The polyester resin composition of the invention gives shaped articles, especially heat-resistant blow-molded articles having excellent transparency, having moderate and stable crystallization rate and having excellent heat-resistant dimensional stability and flavor retentiveness. Even when the composition is exposed to excess drying before shaped, it may still give shaped articles of stable quality.

TABLE 1

| | | | | | | | | | | | | Comp. |
|---|---|---|---|---|---|---|---|---|---|---|---|---|
| | | | Example | | | | | | | | | Example |
| Items (fluorescence-emitting characteristics) | | | 1-1 | 1-2 | 2 | 3 | 4 | 5 | 6 | 7 | 8 | 1 |
| Randomly- | 450 nm fluorescence intensity | B₀ | 6.4 | 6.7 | 4.3 | 6.8 | 6.5 | 6.7 | 6.5 | 6.4 | 6.2 | 22.3 |
| sampled | 395 nm fluorescence intensity | A₀ | 62.2 | 63.0 | 73.0 | 63.0 | 60.0 | 58.0 | 61.0 | 63.0 | 61.1 | 37.0 |
| chips | 450 nm fluorescence intensity | Bₕ | 18.4 | 18.5 | 7.3 | 13.8 | 15.5 | 19.2 | 18.7 | 18.4 | 19.0 | 55.3 |
| | after heat treatment | | | | | | | | | | | |
| | 395 nm fluorescence intensity | Aₕ | 39.0 | 40.2 | 50.0 | 40.5 | 40.0 | 39.0 | 40.1 | 39.3 | 42.0 | 35.0 |
| | after heat treatment | | | | | | | | | | | |
| | fluorescence intensity increment | Bₕ-B₀ | 12 | 12 | 3 | 7 | 9 | 12.5 | 12 | 12 | 13 | 33 |
| | after heat treatment | | | | | | | | | | | |
| | fluorescence intensity ratio | B₀/A₀ | 0.10 | 0.11 | 0.06 | 0.11 | 0.11 | 0.12 | 0.11 | 0.10 | 0.10 | 0.60 |
| | fluorescence intensity ratio | Bₕ/Aₕ | 0.47 | 0.46 | 0.15 | 0.34 | 0.39 | 0.49 | 0.47 | 0.47 | 0.45 | 1.58 |
| | after heat treatment | | | | | | | | | | | |
| | fluorescence intensity ratio | Bₕ/Aₕ₋ | 0.37 | 0.35 | 0.09 | 0.23 | 0.28 | 0.38 | 0.36 | 0.37 | 0.35 | 0.98 |
| | difference after heat treatment | B₀/A₀ | | | | | | | | | | |
| Selected | 450 nm fluorescence intensity | Bₛ₀ | 2.5 | 2.5 | 1.9 | 2.6 | 2.5 | 2.6 | 3.3 | 2.6 | 3.4 | 16 |
| chips | 395 nm fluorescence intensity | Aₛ₀ | 48.0 | 48.0 | 53.0 | 47.2 | 47.4 | 46.2 | 53.2 | 48.2 | 53.1 | 31.0 |
| | 450 nm fluorescence intensity | Bₛₕ | 7.1 | 7.0 | 3.5 | 5.1 | 5.8 | 7.2 | 10.3 | 7.0 | 10.2 | 49.0 |
| | after heat treatment | | | | | | | | | | | |
| | 395 nm fluorescence intensity | Aₛₕ | 31.0 | 31.3 | 41.0 | 31.2 | 31.5 | 30.8 | 34.0 | 32.0 | 33.0 | 30.0 |
| | after heat treatment | | | | | | | | | | | |
| | fluorescence intensity increment | Bₛₕ-Bₛ₀ | 4.6 | 4.5 | 1.6 | 2.5 | 3.3 | 4.6 | 7.0 | 4.4 | 6.8 | 33 |
| | after heat treatment | | | | | | | | | | | |
| | fluorescence intensity ratio | Bₛ₀/Aₛ₀ | 0.05 | 0.05 | 0.04 | 0.06 | 0.05 | 0.06 | 0.06 | 0.05 | 0.06 | 0.52 |
| | fluorescence intensity ratio | Bₛₕ/Aₛₕ | 0.23 | 0.22 | 0.09 | 0.16 | 0.18 | 0.23 | 0.30 | 0.22 | 0.31 | 1.63 |
| | after heat treatment | | | | | | | | | | | |

TABLE 2

| | | | Example | | | | | | | | | Com. Ex. |
|---|---|---|---|---|---|---|---|---|---|---|---|---|
| Items (general properties | | | 1-1 | 1-2 | 2 | 3 | 4 | 5 | 6 | 7 | 8 | 1 |
| Properties | | IV (dl/g) | 0.74 | 0.75 | 0.75 | 0.75 | 0.75 | 0.75 | 0.75 | 0.74 | 0.75 | 0.74 |
| of Polyester | | color b value | 1.8 | 0.7 | 0.3 | 2.3 | 1.5 | 2.0 | 1.3 | 1.8 | 1.5 | 4.6 |
| Resin | | increment after | | | | | | | | | | |
| | | heat treatment | | | | | | | | | | |
| | | CT amount (wt. %) | 0.45 | 0.33 | 0.40 | 0.39 | 0.42 | 0.43 | 0.33 | 0.45 | 0.33 | 0.46 |
| | | ΔCT amount | 0.47 | 0.46 | 0.45 | 0.47 | 0.46 | 0.45 | 0.12 | 0.47 | 0.12 | 0.45 |
| | | (wt. %) | | | | | | | | | | |
| | | DEG content | 2.6 | 2.7 | 2.6 | 2.6 | 2.8 | 2.6 | 2.7 | 2.6 | 2.7 | 2.9 |
| | | (mol %) | | | | | | | | | | |
| | | AA content (ppm) | 2.9 | 3.0 | 3.1 | 3.0 | 3.1 | 2.9 | 3.1 | 2.9 | 3.1 | 4.3 |
| | | remaining | Ge:41 | Ge:48 | Al:20 | Ti:3/Mg:2 | Sb:185/Mg:12 | Ge:40 | Ge:47 | Ge:41 | Ge:46 | Ge:40 |
| | | catalyst amount | | | | | | | | | | |
| | | (ppm) | | | | | | | | | | |
| | | remaining P | 25 | 29 | 36 | 6 | 18 | 24 | 25 | 25 | 25 | 25 |
| | | amount (ppm) | | | | | | | | | | |
| | | amount of fines | 50 | 50 | 63 | 55 | 50 | 50 | 55 | 46 | 55 | 50 |
| | | (ppm) | | | | | | | | | | |
| | | m.p. of fines | 248 | 249 | 248 | 250 | 251 | 249 | 249 | 250 | 251 | 252 |
| | | (° C.) | | | | | | | | | | |
| Properties of | | molded plate | 169 | 171 | 170 | 172 | 169 | 170 | 168 | 163 | 163 | 143 |
| Molded Plate | | Tc1 (° C.) | | | | | | | | | | |
| | | molded plate | 4.2 | 4.0 | 4.9 | 3.8 | 5.2 | 4.5 | 4.8 | 4.4 | 5.1 | 32.2 |
| | | haze (%) | | | | | | | | | | |
| | | molded plate | 0.2 | 0.2 | 0.2 | 0.2 | 0.3 | 0.2 | 0.2 | 0.2 | 0.2 | 3.69 |
| | | haze mottles (%) | | | | | | | | | | |
| | | dimensional | 3.2 | 3.2 | 3 | 2.9 | 2.2 | 3.3 | 3.1 | 2.8 | 2.9 | 0.6 |
| | | change | | | | | | | | | | |
| Bottle | mouth | density (g/cm³) | 1.378 | 1.378 | 1.379 | 1.378 | 1.380 | 1.378 | 1.379 | 1.380 | 1.381 | 1.397 |
| | part | density | 0.002 | 0.002 | 0.002 | 0.002 | 0.002 | 0.002 | 0.002 | 0.002 | 0.002 | 0.01 |
| | | deviation | | | | | | | | | | |
| | | (g/cm³) | | | | | | | | | | |
| | | deformation | no | no | no | no | no | no | no | no | no | no |
| | | content leakage | no | no | no | no | no | no | no | no | no | yes |

| | | | | | | | | | | |
|---|---|---|---|---|---|---|---|---|---|---|
| body part haze (%) | 1.0 | 0.9 | 1.2 | 0.9 | 1.4 | 1.0 | 1.1 | 1.1 | 1.2 | 12.2 |
| AA content (ppm) | 21.0 | 20.0 | 21.3 | 24.0 | 23.5 | 24.0 | 16.0 | 22.0 | 21.0 | 23.1 |
| black light | no | no | no | no | no | no | no | no | no | serious |
| observation | problem | problem | problem | problem | problem | problem | problem | problem | problem | fluorescence |
| | | | | | | | | | | emission |

1. A polyester resin mainly comprising a terephthalic acid component and a glycol component, wherein the fluorescence spectrum obtained by irradiating the polyester resin with excited light having a wavelength of 343 nm has a fluorescence intensity at 450 nm (B₀) of 20 or lower.

2. A polyester resin mainly comprising a terephthalic acid component and a glycol component, which gives (Bₕ-B₀) of 30 or less, wherein Bₕ indicates the fluorescence intensity at 450 nm of the fluorescence spectrum obtained by irradiating the polyester resin that has been heat-treated at a temperature of 180° C. for 10 hours, with excited light having a wavelength of 343 nm, and B₀ indicates the fluorescence intensity at 450 nm, obtained in the same manner, of the non-heated polyester resin.

3. The polyester resin as claimed in claim 1, which gives (Bₕ-B₀) of 30 or less, wherein Bₕ indicates the fluorescence intensity at 450 nm of the fluorescence spectrum obtained by irradiating the polyester resin that has been heat-treated at a temperature of 180° C. for 10 hours, with excited light having a wavelength of 343 nm, and B₀ indicates the fluorescence intensity at 450 nm, obtained in the same manner, of the non-heated polyester resin.

4. A polyester resin mainly comprising a terephthalic acid component and a glycol component, which gives (B₀/A₀) of 0.4 or less, wherein A₀ indicates the fluorescence intensity at 395 nm of the fluorescence spectrum obtained by irradiating the polyester resin with excited light having a wavelength of 343 nm, and B₀ indicates the fluorescence intensity at 450 nm thereof.

5. The polyester resin of claim 1, which gives (B₀/A₀) of 0.4 or less, wherein A₀ indicates the fluorescence intensity at 395 nm of the fluorescence spectrum obtained by irradiating the polyester resin with excited light having a wavelength of 343 nm, and B₀ indicates the fluorescence intensity at 450 nm thereof.

6. A polyester resin mainly comprising a terephthalic acid component and a glycol component, which gives a difference between a ratio (Bₕ/Aₕ) and a ratio (B₀/A₀) of 0.7 or less, wherein Aand Bₕ indicate the fluorescence intensities at 395 nm and at 450 nm respectively of the fluorescence spectrum obtained by irradiating the resin that has been heat-treated at a temperature of 180° C. for 10 hours, with excited light having a wavelength of 343 nm, and A₀ and B₀ indicate the fluorescence intensities at 395 nm and at 450 nm respectively, obtained in the same manner, of the nonheated polyester resin.

7. The polyester resin of claim 1, which gives a difference between a ratio (Bₕ/Aₕ) and a ratio (B₀/A₀) of 0.7 or less, wherein Aand Bₕ indicate the fluorescence intensities at 395 nm and at 450 nm respectively of the fluorescence spectrum obtained by irradiating the polyester resin that has been heat-treated at a temperature of 180° C. for 10 hours, with excited light having a wavelength of 343 nm, and A₀ and B₀ indicate the fluorescence intensities at 395 nm and at 450 nm respectively, obtained in the same manner, of the nonheated polyester resin.

8. A polyester resin, which gives (Bₛ₀/Aₛ₀) of 0.3 or less, wherein Aₛ₀ and Bₛ₀ indicate the fluorescence intensities at 395 nm and 450 nm respectively of the fluorescence spectrum obtained by irradiating a chip selected from the polyester resin which mainly comprises a terephthalic acid component and a glycol component and which is in the form of chip, with excited light having a wavelength of 343 nm.

9. A chip-shaped polyester resin, which gives (Bₛ₀/Aₛ₀) of 0.3 or less, wherein Aₛ₀ and Bₒ₀ indicate the fluorescence intensities at 395 nm and at 450 nm respectively of the fluorescence spectrum obtained by irradiating a selected fluorescence-emitting chip which is the polyester resin of claim 1 and which is in the form of chip, with excited light having a wavelength of 343 nm.

10. A polyester resin, which gives (Bₛₕ/Aₛₕ) of 0.5 or less, wherein Aₛₕ and Bₛₕ indicate the fluorescence intensities at 395 nm and at 450 nm respectively of the fluorescence spectrum obtained by irradiating a fluorescence-emitting chip selected from the polyester resin in the form of chip which mainly comprising a terephthalic acid component and a glycol component and which has been heat-treated at a temperature of 180° C. for 10 hours, with excited light having a wavelength of 343 rim.

11. A polyester resin, which gives (Bₛₕ/Aₛₕ) of 0.5 or less, wherein Aₛₕ and Bₛₕ, indicate the fluorescence intensities at 395 nm and at 450 nm respectively of the fluorescence spectrum obtained by irradiating a fluorescence-emitting chip selected from the polyester resin of claim 1 in the form of chip of which has been heat-treated at a temperature of 180° C. for 10 hours, with excited light having a wavelength of 343 nm.

12. The polyester resin of claim 1, which gives an increment in color b value when heat-treated at a temperature of 180° C. for 10 hours of 4 or less.

13. The polyester resin of claim 1, which comprises ethylene terephthalate as a main repetitive unit and which has a cyclic trimer content of 0.7% by weight or less.

14. The polyester resin of claim 1, which gives an increment of cyclic ester oligomer when melted at a temperature of 290° C. for 60 minutes of 0.50% by weight or less.

15. The polyester resin of claim 1, which contains polyester fines having the same composition as that of the polyester in an amount of from 0.1 to 10000 ppm, wherein the fines have a melting point, as measured through DSC, of 265 C or lower.

16. The polyester resin of claim 1, which gives a dimensional change, as measured through thermomechanical analysis (TMA) on a shaped plate obtained through injection molding of the resin and having a thickness of 3 mm, of from 1.0% to 7.0%.

17. A polyester resin composition comprising the polyester resin of claim 1, and at least one resin selected from the group consisting of polyolefin resin, polyamide resin and polyacetal resin in an amount of from 0.1 ppb to 50000 ppm of the polyester resin.
